(19) United States
(12) Patent Application Publication
(10) Pub. No.: US 2016/0183001 A1
(43) Pub. Date: Jun. 23, 2016

(54) SHARING CUSTOM AUDIO PROFILE INSTRUCTIONS

(71) Applicant: ROAM, INC., TIBURON, CA (US)

(72) Inventors: STEVEN MICHAEL LAMAR, TIBURON, CA (US); PHILIP CLARK BUNCH, COLUMBIA, TN (US)

(21) Appl. No.: 15/056,165

(22) Filed: Feb. 29, 2016

Related U.S. Application Data
(63) Continuation of application No. 14/315,154, filed on Jun. 25, 2014.

(51) Int. Cl. H04R 3/04; H04R 1/10; H04L 29/08

(52) U.S. Cl. CPC H04R 3/04; H04L 67/34; H04R 1/1041

(57) ABSTRACT

Systems and methods for the use of headphones are provided. The systems and methods can offer ease of carrying, comfort, and/or use of headphones, particularly portable headphones that provide for a user adjustment of an audio equalizer setting directly at the headphones for a desired audio data frequency/amplitude profile. Moreover, a combination of the concepts of user-controlled sound dynamics are provided at the headphone device through computerized pendant that is configured to alter sound dynamics directly through it's own software application without needing to control the sound dynamics at the audio source. This allows a user of the headphones to switch between audio devices while maintaining a desired set of sound dynamics in the form of preset or custom audio profiles.

### CROSS-REFERENCE TO RELATED APPLICATIONS

This application is a continuation of U.S. application Ser. No. 14/315,154, filed Jun. 25, 2014, which is hereby incorporated by reference in its entirety.

### BACKGROUND

1. Field of the Invention

The teachings are directed to portable headphone and earphone systems and methods for a user adjustment of an audio equalizer setting for a customized listening of audio data.

2. Description of the State-of-the-Art

Portable headphones and earphones are currently used for many reasons, each of which is for a listener to receive an audio data from an audio output device. Examples of audio devices include, but are not limited to, CD or DVD players, home theater systems, personal computers, iPads, and portable devices that can include, for example, digital audio players, mp3 players, hearing aids, mobile phones, smart phones, pda's, notepads, etc, and the like. It should be appreciated that there are numerous applications for headsets including, for example, listening to music, amplifying sound for the hearing impaired or surveillance, telephone use, and console or PC gaming. Regardless of the application, one of skill will appreciate having a system to adjust the tone or frequency response of an audio system to achieve a desired sound output.

One reason to adjust the tone, frequency response or overall gain level of an audio system is to compensate for a frequency distortion received from an audio device, for example, a distortion due at least in part to the use of a battery-powered audio device. Low-impedance headphones and earphones are typically in the range of about 16 to 32 ohms and high-impedance headphones are in the range of about 100-600 ohms. One of skill will appreciate that the impedance of headphones has generally decreased to accommodate the lower voltages available from the battery-powered CMOS-based portable devices, such that headphones can now be more efficiently driven by such devices. To avoid distortion, the amplifier of the audio device should be designed with an impedance that is significantly less than the impedance of the headphones. For at least the reason that headphones and audio device amplifiers are not always properly matched, one of skill will appreciate having the technology in portable headphones to alter the relative strengths of different frequencies in an audio data received from the audio device to compensate for frequency distortions.

Another reason to adjust the tone, frequency response or overall gain level of an audio system is to compensate for ambient noise received from sources external to an audio device. Ear-fitting headphones or canalphones such as earbuds and in-ear headphones are portable and convenient designs. Earbuds and canalphones often allow ambient noise from the environment to enter with the audio from the audio device. Sometimes this is intentional, such that the user is better aware of his surroundings when sound is a necessary cue for safety or other reasons, as when walking, driving, or riding near or in vehicular traffic. Ear-fitting phones can remove some ambient noise, the extent of removal depending on the quality of fit to the inner ear. One problem with ambient noise is that it affects the quality of the audio that is heard by the user of the headphones. Another problem is that users may turn up the volume dangerously high to compensate for the ambient noise to enable hearing what they want to hear while increasing the risk of hearing loss. For at least these reasons, one of skill will appreciate having the technology in portable headphones to alter the relative strengths of different frequencies in an audio data received from the audio device to compensate for ambient noise.

Another reason to adjust the tone, frequency response or overall gain level of an audio system is to compensate for uncontrollable variations in volume from an audio device. For example, the audio received by a user from a cell phone can vary according to the quality of data received by the cell phone, which is an uncontrollable variation. In another example, audio volume output might simply vary from device-to-device due to individual device settings or malfunction, for example, the sound levels designed into a pda, a gaming console, an mp3 player, or an airline company's inflight-entertainment media device. For at least these reasons, one of skill will appreciate having the technology in portable headphones to alter the relative strengths of different frequencies in an audio data received from the audio device to compensate for uncontrollable variations in volume from the audio device.

Another reason to adjust the tone, frequency response or overall gain level of an audio system is to compensate for uncontrollable variations in how the sound frequencies are received by a user. Not all people hear sound equally, which can be due to normal variations between users or, perhaps, any of a variety of hearing disorders associated with a hearing loss that can be in one or both ears. Globally, hearing loss affects about 10% of the population, making it one of the most common medical conditions and, as such, makes it a significant problem to be addressed for the user of audio devices. It is to be appreciated that, since hearing loss can be frequency-specific, as well as non-frequency-specific, one of skill will appreciate having the technology in portable headphones to alter the relative strengths of different frequencies in an audio data received from the audio device to compensate for uncontrollable variations in the manner in which sound frequencies are received by a variety of users.

Another reason to adjust the tone, frequency response or overall gain level of an audio system is to customize how sound is received to address a listening preference. The listening preference can include a preselected distribution of frequencies and amplitudes, an audio pattern in which sound frequencies and amplitudes are chosen by the user. Users enjoy adjusting the sound dynamics (bass, treble, frequency/volume faders, left balance, right balance, etc.) of audio. For example, user's like to control the relative amplitude, frequency and balance of the audio received from an audio device. User's also enjoy sharing their taste in music, for example, and this includes sharing their preferred frequency/amplitude distributions. Moreover, user's also enjoy having customized or default frequency/amplitude distribution settings that can be easily selected, subjectively, to meet a current preference, such as custom pre-sets that can be easily selected as pre-tuned for the listening device, optimizing the sound dynamics for a specific genre of sound: e.g., jazz music, hip-hop music, rock music, classical music or country music; as well as movies, TV shows, and the like. For at least these reasons, one of skill will appreciate having the technology in portable headphones to alter the relative strengths of different frequencies in an audio data received from the audio device to customize sound according to a listening preference.

Currently, portable headphones, such as earbuds and in-ear headphones, do not have the ability to adjust the amplitude of audio data at particular frequencies to address the above problems. Accordingly, one of skill in the art will appreciate having methods and systems for a customized listening of audio data to adjust the amplitude of the tone or frequency output of an audio system to (i) to compensate for frequency distortions received from an audio device; (ii) to compensate for ambient noise from an audio device; (iii) to compensate for uncontrollable variations in volume from an audio device; (iv) to compensate for uncontrollable variations in the manner in which sound frequencies are received from an audio device; and, (v) to customize how sound is received from an audio device according to a listening preference.

### SUMMARY

Systems and methods for the use of headphones are provided herein. The systems and methods provided herein can, for example, offer ease of carrying, comfort, and/or use of headphones, particularly portable headphones that provide for a user adjustment of an audio equalizer setting directly at the headphones for a desired audio data frequency/amplitude profile. Moreover, the teachings provided herein include a combination of the concepts of user-controlled sound dynamics through an equalizer function with a headphone system that alters sound dynamics directly through it's own software application without needing to control the sound dynamics at the audio source. This allows a user of the headphones to switch between audio devices while maintaining a desired set of sound dynamics in the form of preset or custom audio profiles.

As such, a computerized, portable headphone system is provided. The system can comprise a set of headphones having a left ear speaker operably attached to a left cable brace with a top-end and bottom-end and a right ear speaker operably attached to a right cable brace with a top-end and a bottom-end. The system can also include a neckstrap having a left-end operably attached to the top-end of the left cable brace and a right-end operably attached to the top-end of the right cable brace. A computerized pendant can be operably attached to the headphones, the pendant being configured for hanging ventrally below a user's chin during use. The computerized pendant can be configured with a computer having a processor and a memory operably connected to the processor for a transforming of an input audio data set. The transforming includes creating a structured output audio profile from the input audio data set, the output audio profile having a preselected distribution of relative audio amplitudes over a corresponding set of audio frequencies. The memory of the computer can be configured to include a database on a non-transitory computer readable medium for storing a set of output audio instructions, the output audio instructions configured for the transforming of the input audio data set into the structured output audio profile. The memory can also be configured to include a transformation module on a non-transitory computer readable medium for executing the set of output audio instructions, the executing including transforming the input audio data set into the structured output audio profile. The memory can also be configured to include an output module on a non-transitory computer readable medium for sending the structured output audio profile to the headphones. And, the pendant can also include an energy source in an operable connection with the computer. In order to connect the headphones with the pendant, the systems can include a left cable operably connecting the output module of the computer to the left ear speaker through the bottom of the left cable brace; and, a right cable cable operably connecting the output module of the computer to the right ear speaker through the bottom of the right cable brace.

Pendants having an amplifier circuit can be used. One of skill will appreciate that the systems can benefit by the ability to amplify frequencies of the input audio data set in the transforming of the input audio data set into the structured output audio profile. In some embodiments, the pendant provides an output audio having a structured output audio profile to sole user of the system, and an amplifier circuit provides additional power to add frequency amplitude desired by the user. In some embodiments, the pendant provides an output audio having a structured output audio profile to two users of the system, the output audio being shared by a right cable user connected to a park/share port in the pendant having an amplifier circuit which provides additional power to add frequency amplitude as desired, or perhaps needed in some embodiments, by the two users.

In some embodiments, the pendant further comprises a selection engine on a non-transitory computer readable medium for selecting a set of output audio instructions from a plurality of sets of output audio instructions. The set of output audio instructions can represent a single, structured output audio profile, or it can include a plurality of structured output audio profiles. The plurality of structured output audio profiles can be fixed upon download, or the computer in the pendant can have the functionality of starting with a particular structured output audio profile that can be altered at the headphone system by the user. In some embodiments, the set of output audio instructions can be a software download that alters, or augments, a current set of audio instructions residing in the memory of the computer of the headphones. For example, a system provided herein may contain a set of output audio instructions called “Rock”, and an update may be available, a “patch” to alter or correct the current structure of the audio profile of the “Rock” instructions at the headphone system. In order to receive a set of output audio instructions, a receiving module on a non-transitory computer readable medium can be provided in the memory of the computer for receiving a set of user-selected output audio instructions from a peripheral device. The receiving module can be operably connected to the database for storing the set of user-selected output audio instructions. In some embodiments, the receiving module can receive a data download using a wireless technology, such as a BLUETOOTH technology, and the like; and, in some embodiments, the pendant can include a port for connecting a peripheral device to the computer to receive a download such as, for example, the set of user-selected output audio instructions from the peripheral device.

As such, one of skill will appreciate having a system with a pendant that further comprises a combination of an amplifier circuit; a receiving module on a non-transitory computer readable medium for receiving a set of user-selected output audio instructions from a peripheral device, the receiving module operably connected to the database for storing the set of user-selected output audio instructions; and, a port for connecting a peripheral device to the computer to receive the set of user-selected output audio instructions from the peripheral device.

Moreover, one of skill will appreciate having a system with a pendant that further comprises a combination of a receiving module on a non-transitory computer readable medium for receiving a set of user-selected output audio instructions from a peripheral device, the receiving module operably connected to the database for storing the set of user-selected output audio instructions; a port for connecting a peripheral device to the computer to receive the set of user-selected output audio instructions from the peripheral device; and, a selection engine on a non-transitory computer readable storage medium for selecting a set of output audio instructions from a plurality of sets of output audio instructions.

Moreover, one of skill will appreciate having a system with a pendant that further comprises a combination of an amplifier circuit; a receiving module on a non-transitory computer readable storage medium for receiving a set of user-selected output audio instructions from a peripheral device, the receiving module operably connected to the database for storing the set of user-selected output audio instructions; a port for connecting a peripheral device to the computer to receive the set of user-selected output audio instructions from the peripheral device; and, a selection engine on a non-transitory computer readable storage medium for selecting a set of output audio instructions from a plurality of sets of output audio instructions.

In some embodiments, the pendant can contain state selectors that can be activated by touch control. In some embodiments, the pendant can contain state selectors that can be activated by voice control. In these embodiments, the state selectors can include, but are not limited to, an on/off state selector to engage or disengage the transformation module, an amplifier state selector to engage or disengage the amplifier circuit, and/or a output audio profile state selector for a selecting of a set of output audio instructions from a plurality of sets of output audio instructions.

In some embodiments, the system can have a control switch operably connected between the set of headphones and the computerized pendant in the left cable or the right cable, the control switch having a state selector for an engaging, or a disengaging, of the transforming of the input audio data set into the structured output audio profile. In some embodiments, the system can have a control switch operably connected between the set of headphones and the computerized pendant in the left cable or the right cable, the control switch having a state selector for an engaging, or a disengaging, of the amplifier circuit. And, in some embodiments, the system can have a control switch operably connected between the set of headphones and the computerized pendant in the left cable or the right cable, the control switch having a state selector for a selecting of a set of output audio instructions from a plurality of sets of output audio instructions.

It should be appreciated that, in most any embodiment, the system can be configured to receive data through a wireless technology, such as a BLUETOOTH technology, and the like. In some embodiments, the pendant can communicate with an audio source through a wireless connection. In some embodiments, the pendant can connect with a cellular phone, or smart phone through a wireless connection, and the system can include a microphone for two-way communications. Likewise, in some embodiments, the pendant itself can comprise a cellular phone technology for sending and receiving cellular data on it's own, such as cellular telephone data.

One of skill will appreciate the functionality of the headphone design, which provides comfort and specificity of the left ear speaker to the left ear, and the right ear speaker to the right ear. In some embodiments, the left ear speaker is operably attached posterior to the left cable brace and the right ear speaker is operably attached posterior to the right cable brace. In some embodiments, the left cable brace is a structural beam and the right cable brace is a structural beam. The left cable brace can be a structural beam having a top portion with a length that is shorter than the bottom portion and the right cable brace can be a structural beam having a top portion with a length that is shorter than the bottom portion. In some embodiments, the left cable brace is a cuboidal beam and the right cable brace is a cuboidal beam. The left cable brace can be a cuboidal beam having a top portion with a length that is shorter than the bottom portion and the right cable brace can be a cuboidal beam having a top portion with a length that is shorter than the bottom portion.

One of skill will also appreciate that the braces and beams can vary significantly in aesthetic appearance, having a vast array of possible aesthetic configurations, while providing the same functionality. In some embodiments, for example, the left cable brace is a twisted beam and the right cable brace is a twisted beam. The left cable brace can be a twisted beam having a top portion with a length that is shorter than the bottom portion and the right cable brace can be a twisted beam having a top portion with a length that is shorter than the bottom portion.

The systems can be designed to facilitate the creation and download of custom audio profiles by a user of the system. As such, in some embodiments, the memory can include a plurality of sets of instructions, at least one of the plurality of sets of instructions instructing the computer to transform the input audio data set into an independent-or-distinct, user-defined output audio profile. Likewise, the systems can be designed to facilitate the ease of selection of one or more default output audio profiles. As such, in some embodiments, the memory includes a plurality of sets of instructions, at least one of the plurality of sets of instructions instructs the computer to transform the input audio data set into a default output audio profile.

A method of constructing a set of computerized, portable headphones is provided. In some embodiments, the method comprises constructing a set of portable headphones having a left ear speaker, a right ear speaker. The constructing can include assembling a pendant having a computer with a processor and a memory operably connected to the processor for a transforming of an input audio data set into a structured output audio profile having a preselected distribution of relative audio amplitudes over a corresponding set of audio frequencies. The method can also include configuring the memory to include a database, a transformation module, and an output module; and, attaching the pendant to hang from the set of portable headphones. The method can also include creating a set of output audio instructions for downloading to the computer, the output audio instructions configured for the transforming of the input audio data set into the structured output audio profile. The set of computerized, portable headphones can be configured function to transform the input audio data set into the structured output audio profile having the preselected distribution of relative audio amplitudes over the corresponding set of audio frequencies for receiving through the left speaker and the right speaker.

A method of transforming an input audio data set into a structured output audio profile having a preselected distribution of relative audio amplitudes over a corresponding set of audio frequencies for receiving through a set of headphones is provided. In some embodiments, the method comprises obtaining a headphone system taught herein. The method can include transforming the input audio data set into the structured output audio profile; and, receiving the structured output audio profile through the set of headphones.

In some embodiments, the method includes obtaining a system having an amplifier circuit and engaging the amplifier circuit to amplify frequencies of the input audio data set in the transforming of the input audio data set into the structured output audio profile.

In some embodiments, the method includes obtaining a system having a selection engine on a non-transitory computer readable storage medium for selecting a set of output audio instructions from a plurality of sets of output audio instructions. And, in some embodiments, the method further comprises selecting a set of output audio instructions from a plurality of sets of output audio instructions using the selection engine.

In some embodiments, the method includes obtaining a system having a receiving module on a non-transitory computer readable medium for receiving a set of user-selected output audio instructions from a peripheral device; and, a port for connecting a peripheral device to the computer. And, in some embodiments, the method further comprises receiving a set of user-selected output audio instructions from the peripheral device.

In some embodiments, the method includes obtaining a system having an amplifier circuit; a receiving module on a non-transitory computer readable medium for receiving a set of user-selected output audio instructions from a peripheral device; and, a port for connecting a peripheral device to the computer to receive the set of user-selected output audio instructions from the peripheral device. And, in some embodiments, the method further comprises engaging the amplifier circuit; and, receiving the set of user-selected output audio instructions from the peripheral device.

In some embodiments, the method includes obtaining a system having a receiving module on a non-transitory computer readable medium for receiving a set of user-selected output audio instructions from a peripheral device; a port for connecting a peripheral device to the computer to receive the set of user-selected output audio instructions from the peripheral device; and, a selection engine on a non-transitory computer readable storage medium for selecting a set of output audio instructions from a plurality of sets of output audio instructions. And, in some embodiments, the method further comprises receiving the set of user-selected output audio instructions from the peripheral device; and, selecting a set of output audio instructions from a plurality of sets of output audio instructions using the selection engine.

In some embodiments, the method includes obtaining a system having an amplifier circuit; a receiving module on a non-transitory computer readable storage medium for receiving a set of user-selected output audio instructions from a peripheral device; a port for connecting a peripheral device to the computer to receive the set of user-selected output audio instructions from the peripheral device; and, a selection engine on a non-transitory computer readable storage medium for selecting a set of output audio instructions from a plurality of sets of output audio instructions. And, in some embodiments, the method further comprises engaging the amplifier circuit; receiving the set of user-selected output audio instructions from the peripheral device; and, selecting a set of output audio instructions from a plurality of sets of output audio instructions using the selection engine.

In some embodiments, the method includes obtaining a system having a control switch operably connected between the set of headphones and the computerized pendant in the left cable or the right cable, the control switch having a state selector for an engaging, or a disengaging, of the transforming of the input audio data set into the structured output audio profile. And, in some embodiments, the method further comprises the engaging, or the disengaging, of the transforming of the input audio data set into the structured output audio profile.

In some embodiments, the method includes obtaining a system having a control switch operably connected between the set of headphones and the computerized pendant in the left cable or the right cable, the control switch having a state selector for an engaging, or a disengaging, of the amplifier circuit. And, in some embodiments, the method further comprises the engaging, or the disengaging, of the amplifier circuit to amplify frequencies of the input audio data set in the transforming of the input audio data set into the structured output audio profile.

In some embodiments, the method includes obtaining a system having a control switch operably connected between the set of headphones and the computerized pendant in the left cable or the right cable, the control switch having a state selector for a selecting of a set of output audio instructions from a plurality of sets of output audio instructions. And, in some embodiments, the method further comprises the selecting of the set of output audio instructions from the plurality of sets of output audio instructions.

### BRIEF DESCRIPTION OF THE DRAWINGS

FIG. 1 is a general technology platform for a system or method taught herein, according to some embodiments.

FIG. 2 illustrates a processor-memory diagram to describe components of the headphone systems taught herein, according to some embodiments.

FIG. 3 is a concept diagram illustrating the system, according to some embodiments.

FIG. 4 illustrates a method for constructing a set of computerized, headphones, according to some embodiments.

FIGS. 5A and 5B illustrate a set of computerized, headphones in use, according to some embodiments.

FIGS. 6A and 6B illustrate a set of computerized, headphones in a front perspective view and frontal view, according to some embodiments.

FIGS. 7A-7C illustrate an enlarged view of a set of computerized, headphones taught herein having an earbud having a cuboidal beam having a top portion with a length that is shorter than the bottom portion in a side-frontal perspective view, a rear view, and a frontal perspective view, according to some embodiments.

FIGS. 8A-8C illustrate an enlarged view of a set of computerized, headphones taught herein with an earbud having a twisted beam having a top portion with a length that is shorter than the bottom portion in a frontal perspective view, rear perspective view, and a top-frontal perspective view, according to some embodiments.

FIG. 9 illustrates a control switch with 3 buttons as state selectors, the control switch operably connected between the set of headphones and the computerized pendant, according to some embodiments.

FIGS. 10A-10C illustrate a variety of control switches with 4 buttons as state selectors, each of the control switches operably connected between the set of headphones and the computerized pendant according to some embodiments.

FIG. 11 illustrates a transforming of an input audio data set into a structured output audio profile using a computerized, headphone system taught herein, according to some embodiments.

FIGS. 12A and 12B illustrate screenshots of a software interface control panel with state selectors for (i) creating instructions for transforming an input audio data set into a structured output audio profile having a preselected distribution of relative audio amplitudes over a corresponding set of audio frequencies using a computerized, headphone system taught herein; (ii) accessing preset instructions; (iii) saving custom profiles; and (iv) sharing the instructions within a network community, according to some embodiments.

FIG. 13 illustrates an interface between a computerized, headphone system taught herein, and a peripheral computing device, according to some embodiments.

FIG. 14 illustrates a processor-memory diagram to describe components of a peripheral computer system that interfaces with a headphone system taught herein, according to some embodiments.

FIG. 15 illustrates an interface between a computerized, headphone system taught herein, a peripheral computing device, and a network computing system, according to some embodiments.

FIGS. 16A and 16B illustrate the use of a computerized, headphone system taught herein by (i) a single user or (ii) a shared use by two users at a park/share port, according to some embodiments.

FIG. 17 illustrates a function of a control switch for a single user, the control switch having 3 buttons as state selectors and operably connected between the set of headphones and the computerized pendant, the pendant having an indicator light showing the status of each state selector, according to some embodiments.

FIG. 18 illustrates a function of a control switch for a shared use of the system, the control switch having 3 buttons as state selectors and operably connected between the set of headphones and the computerized pendant, the pendant having an indicator light showing the status of each state selector, according to some embodiments.

FIG. 19 shows how a network may be used for the system, according to some embodiments.

FIGS. 20A and 20B illustrate a system configuration for sharing an output audio with a second user at the computerized pendant of the headphone system, according to some embodiments.

FIGS. 21A-21E illustrate a strut/capsule configuration that indicates left ear and right ear positions, according to some embodiments.

### DETAILED DESCRIPTION

Systems and methods for the use of headphones are provided herein. The systems and methods provided herein can, for example, offer ease of carrying, comfort, and/or use of headphones, particularly portable headphones that provide for a user adjustment of an audio equalizer setting directly at the headphones for a desired audio data frequency/amplitude profile. Moreover, the teachings provided herein include a combination of the concepts of user-controlled sound dynamics through an equalizer function with a headphone system that alters sound dynamics directly through it's own software application without needing to control the sound dynamics at the audio source. This allows a user of the headphones to switch between audio devices while maintaining a desired set of sound dynamics in the form of preset or custom audio profiles.

One of skill will appreciate that any one or any combination of the terms “headphone,” “earphone”, “canalphone”, “transducer capsule”, and “capsule” might be used interchangeably in some embodiments. That is, one of skill will appreciate that the term “headphone” can be used to encompass a variety of operable connection systems between a user's ear and an audio source. As such, the term “headphone” can be envisioned as the generic term, wherein (i) “circumaural” headphones are full-size headphones that encompass the ears; (ii) “supra-aural” headphones press against the ears; and, (iii) “ear-fitting” headphones include earbuds that are fitted directly into the outer ear facing but not inserted into the ear canal, and canalphones which are inserted into the ear canal. In some embodiments, the systems can comprise a headset, which is a headphone that is combined with a microphone.

For the typical user of an audio device, the sound characteristics (i.e., output audio frequency/amplitude profile or “voicing”) of a digital audio playback system may, or may not, be considered adequate. As such, a user will often want, or perhaps need, to tailor the sound received from a computerized audio system. Current solutions are available by making such adjustments at the audio source, for example, at the PC or handheld, computerized device such as, for example, an IPHONE that is processing an input audio data. This solution is limited, as it can only be relied upon as long as that same system combination of audio source and speakers is used. This is because the output audio profile received by a user from a computer audio system is a result of a combination of (i) the configuration of a source audio data, (ii) the configuration of a computer for processing the source audio data, and (iii) the configuration of a set of speakers that produce the sound that is output and received by the user of the system. An example of such a limited solution is an ITUNES player. That is, if a user wants to modify the frequency/amplitude profile of the sound that is received through the speakers, an equalizer functionality present in a software audio player can be used such as, for example, the ITUNES player. The software audio player can configure a customized voicing for the source audio data, perhaps by adding a little more bass amplitude and/or perhaps cutting the high frequency amplitude by a desired amount, to form a modified, source audio data that has the output audio profile sought by the user when processed by that particular audio source. The sound received from modified, source audio data will change, however, upon a change in the particular configuration of the computer and speaker system used to process the source audio data. For example, switching from an IPHONE with canal phones to the IPHONE with earbuds, switching from an IPHONE with earbuds to an IPHONE with full-size (curcumaural) headphones, or switching from an IPHONE with full-size headphones to the IPHONE with at a docking station with speakers, can each change the output audio profile received by the user.

The systems and methods provided herein provide a solution to this audio source limitation by offering an alternative solution that includes creating the desired output audio profile in the digital domain at the computerized pendant in the headphone system. First, the user connects their computerized pendant to their desktop computer, portable, or handheld computerized device, each of which has interfacing software that communicates with software in the computerized pendant as taught herein. Once connected, the app allows the user to adjust the equalizer settings, or output audio profile, produced at the earphone system. These equalizer settings can be saved to the device on exit and can remain in that state until the user changes them. The unique solution is that the computerized headphone can continue to produce the desired audio profile regardless of the audio source used, meaning that the system will continue to sound the way that the user prefers across all audio sources without requiring further adjustment at the audio source.

In some embodiments, the computerized headphone system can be configured to offer digital signal processing (DSP) to provide an overall DSP effect, for example, soundfield depth, envelope, echo, flanger, phaser, chorus, equalization, filtering, overdrive effects such as fuzz-box, pitch shift, time stretching, resonators, robotic voice effects, synthesizer, modulation, compression, 3D audio effects, reverse echo, active noise control, and wave field synthesis.

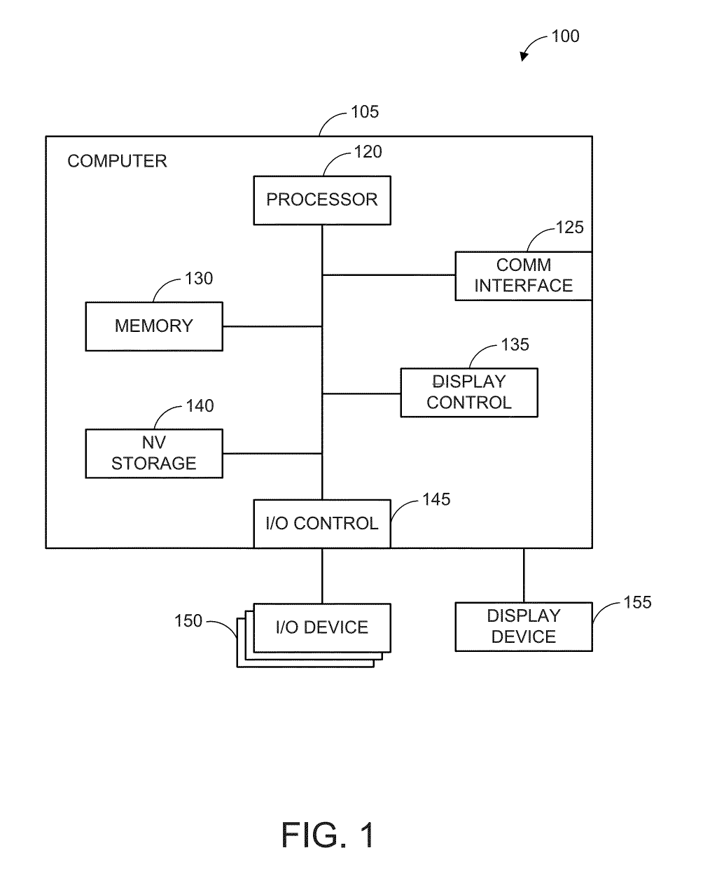

FIG. 1 shows a general technology platform for the system, according to some embodiments. The computer system 100 may be a conventional computer system and includes a computer 105, I/O devices 150, and a display device 155. The computer 105 can include a processor 120, a communications interface 125, memory 130, display controller 135, non-volatile storage 140, and I/O controller 145. The computer system 100 may be coupled to or include the I/O devices 150 and display device 155.

The computer 105 interfaces to external systems through the communications interface 125, which may include a modem or network interface. It will be appreciated that the communications interface 125 can be considered to be part of the computer system 100 or a part of the computer 105. The communications interface 125 can be an analog modem, isdn modem, cable modem, token ring interface, satellite transmission interface (e.g. “direct PC”), or other interfaces for coupling the computer system 100 to other computer systems. In a cellular telephone, this interface is typically a radio interface for communication with a cellular network and may also include some form of cabled interface for use with an immediately available personal computer. In a two-way pager, the communications interface 125 is typically a radio interface for communication with a data transmission network but may similarly include a cabled or cradled interface as well. In a personal digital assistant, the communications interface 125 typically includes a cradled or cabled interface and may also include some form of radio interface, such as a BLUETOOTH or 802.11 interface, or a cellular radio interface, for example.

The processor 120 may be, for example, any suitable processor, such as a conventional microprocessor including, but not limited to, an Intel Pentium microprocessor or Motorola power PC microprocessor, a Texas Instruments digital data processor, or a combination of such components. The memory 130 is coupled to the processor 120 by a bus. The memory 130 can be dynamic random access memory (DRAM) and can also include static ram (SRAM). The bus couples the processor 120 to the memory 130, also to the non-volatile storage 140, to the display controller 135, and to the I/O controller 145. In some embodiments, an ADI chipset can be used, such as an ADAU 1772 with, for example, a 192 kHz processor.

The I/O devices 150 can include a keyboard, disk drives, printers, a scanner, and other input and output devices, including a mouse or other pointing device. The display controller 135 may control in the conventional manner a display on the display device 155, which can be, for example, a cathode ray tube (CRT), liquid crystal display (LCD), light-emitting diode (LED), or organic light-emitting diode OLED. The display controller 135 and the I/O controller 145 can be implemented with conventional well known technology, meaning that they may be integrated together, for example.

The non-volatile storage 140 is often a FLASH memory or read-only memory, or some combination of the two. A magnetic hard disk, an optical disk, or another form of storage for large amounts of data may also be used in some embodiments, although the form factors for such devices typically preclude installation as a permanent component in some devices. Rather, a mass storage device on another computer is typically used in conjunction with the more limited storage of some devices. Some of this data is often written, by a direct memory access process, into memory 130 during execution of software in the computer 105. One of skill in the art will immediately recognize that the terms “machine-readable medium” or “computer-readable medium” includes any type of storage device that is accessible by the processor 120 and also encompasses a carrier wave that encodes a data. Objects, methods, inline caches, cache states and other object-oriented components may be stored in the non-volatile storage 140, or written into memory 130 during execution of, for example, an object-oriented software program.

The computer system 100 is one example of many possible different architectures. For example, personal computers based on an Intel microprocessor often have multiple buses, one of which can be an I/O bus for the peripherals and one that directly connects the processor 120 and the memory 130 (often referred to as a memory bus). The buses are connected together through bridge components that perform any necessary translation due to differing bus protocols.

In addition, the computer system 100 can be controlled by operating system software which includes a file management system, such as a disk operating system, which is part of the operating system software. One example of an operating system software with its associated file management system software is the family of operating systems known as WINDOWS, WINDOWS CE, WINDOWS PHONE, and WINDOWS RT, from Microsoft Corporation of Redmond, Wash., and their associated file management systems. Another example of operating system software with its associated file management system software is the LINUX operating system and its associated file management system. Another example of an operating system software with its associated file management system software is the PALM operating system and its associated file management system. Another example of an operating system is an ANDROID, or perhaps an iOS, operating system. The file management system is typically stored in the non-volatile storage 140 and causes the processor 120 to execute the various acts required by the operating system to input and output data and to store data in memory, including storing files on the non-volatile storage 140. Other operating systems may be provided by makers of devices, and those operating systems typically will have device-specific features which are not part of similar operating systems on similar devices. Similarly, WinCE®, PALM, IOS or ANDROID operating systems, for example, may be adapted to specific devices for specific device capabilities.

The computer system 100 may be integrated onto a single chip or set of chips in some embodiments, and can be fitted into a small form factor for use as a personal device. Thus, it is not uncommon for a processor, bus, onboard memory, and display/I-O controllers to all be integrated onto a single chip. Alternatively, functions may be split into several chips with point-to-point interconnection, causing the bus to be logically apparent but not physically obvious from inspection of either the actual device or related schematics.

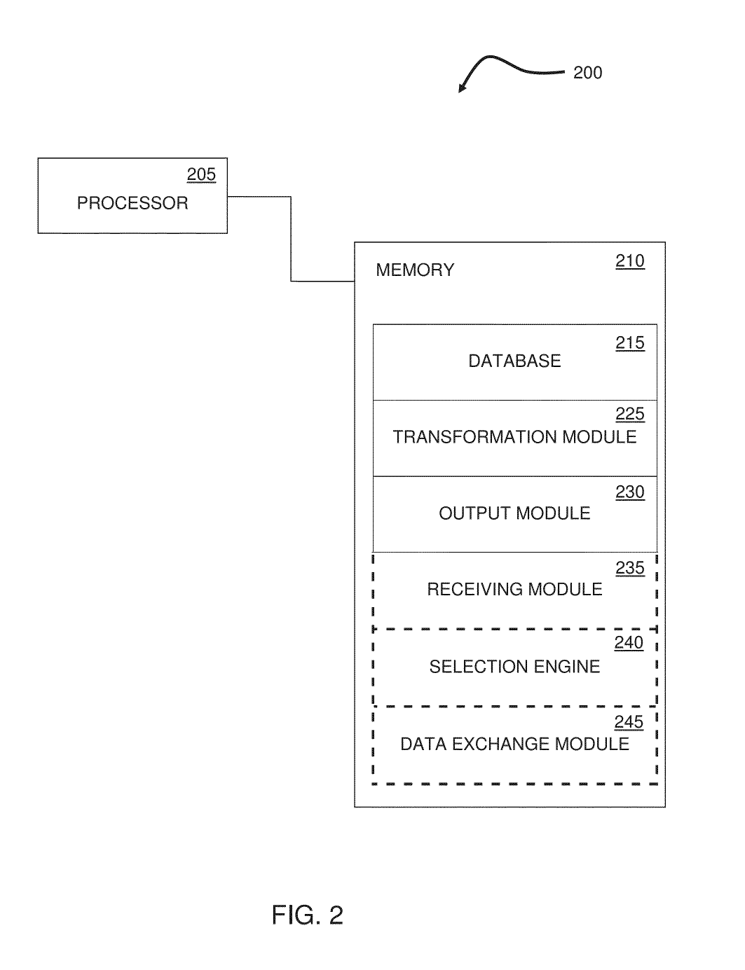

FIGS. 2A and 2B illustrate processor-memory diagrams to describe components of the system, according to some embodiments. In FIG. 2A, the system 200 shown in FIG. 2 contains a processor 205 and a memory 210 (that can include non-volatile memory), wherein the memory 210 includes a database 215, a transformation module 225, and an output module 230. The system can also have a receiving module 235 on a non-transitory computer readable medium for receiving a set of user-selected output audio instructions from a peripheral device, the receiving module 235 operably connected to the database for storing the set of user-selected output audio instructions. The instructions can be received, for example, through a port for connecting a peripheral device to the computer to receive the set of user-selected output audio instructions from the peripheral device. The system can also have a selection engine 240 on a non-transitory computer readable storage medium for selecting a set of output audio instructions from a plurality of sets of output audio instructions. Moreover, the system can further comprise an optional data exchange module 245 embodied in a non-transitory computer readable medium, wherein the data exchange module is operable to exchange data with external computer readable media.

The system includes an input device (not shown) operable to receive audio data on a non-transitory computer readable medium. Examples of input devices include a data exchange module operable to interact with external data formats, voice-recognition software, a hand-held device in communication with the system including, but not limited to, a microphone, and the like. It should be appreciated that the input and output can be an analog or digital audio,

The audio database 215 is operable to store audio files for access on a non-transitory computer readable storage medium. In some embodiments, the system can store original multi-track audio files, copies of original multi-track audio files, and the like. Any audio file known to one of skill in the art can be stored including, but not limited to sound files, text files, image files, and the like. In some embodiments, the system can access any of a variety of accessible data through a data exchange module, as discussed above.

Any audio format known to one of skill in the art can be used. In some embodiments, the audio file comprises a format that supports one audio codec and, in some embodiments, the audio file comprises a format that supports multiple codecs. In some embodiments the audio file comprises an uncompressed audio format such as, for example, WAV, AIFF, and AU. In some embodiments, the audio file format comprises lossless compression such as, FLAC, Monkey's Audio having file extension APE, WayPack having file extension WV, Shorten, Tom's lossless Audio Kompressor (TAK), TTA, ATRAC Advanced Lossless, Apple Lossless, and lossless WINDOWS Media Audio (WMA). In some embodiments, the audio file format comprises lossy compression, such as MP3, Vorbis, Musepack, ATRAC, lossless WINDOWS Media Audio (WMA) and AAC.

In some embodiments, the audio format is an uncompressed PCM audio format, as a “.way” for a WINDOWS computer readable media, or as a “.aiff” as a MAC OS computer readable media. In some embodiments a Broadcast Wave Format (BWF) can be used, allowing metadata to be stored in the file. In some embodiments, the audio format is a lossless audio format, such as FLAC, WayPack, Monkey's Audio, ALAC/Apple Lossless. In some embodiments, the lossless audio format provides a compression ratio of about 2:1. In some embodiments, the audio format is a free-and-open format, such as way, ogg, mpc, flac, aiff, raw, au, or mid, for example. In some embodiments, the audio format is an open file format, such as gsm, dct, vox, aac, mp4/m4a, or mmf. In some embodiments the audio format is a proprietary format, such as mp3, wma, atrac, ra, ram, dss, msv, dvg, IVS, m4p, iklax, mxp4, and the like.

The transformation module 220 is operable to transform an input audio data set into a structured output audio profile having a preselected distribution of relative audio amplitudes over a corresponding set of audio frequencies. It should be appreciated that a “gain ratio” can be used to refer to a user-controlled variable sound level relationship between the minimum (inaudible) sound volume (infinity:1) to maximum loudness output (0 dB full scale with a ratio of 1:1). The terms “gain” and “volume” can be used interchangeably in some embodiments, where a gain of “0” can be used, in some embodiments, as a reference for a minimum volume of an audio portion, track or otherwise; and, a ratio of 0 can be used to refer to a gain in the numerator of 0. For example, a ratio of the amplitude of one frequency to another of 0 can mean, for example, that at least one of the frequencies has been turned off, or at least down to the minimum volume setting of 0. This setting allows the residual component volume, or gain, to be adjusted to an audible level desired by a user. One of skill will also appreciate that the terms “equalize” and “equalization” can be used to refer to altering an output audio profile by attenuating or boosting different frequency bands across the frequencies of an input audio profile to produce desired spectral characteristics in the output audio profile. Likewise, the term “equalizer” can be used to discuss portion of the systems and methods taught herein that equalize or provide equalization using, for example, a set of output audio instructions through a transformation module on a non-transitory computer readable medium for executing the set of output audio instructions. The executing includes transforming the input audio data set into the structured output audio profile using the set of output audio instructions.

As described above, the system can include an output module 235 embodied in a non-transitory computer readable medium. The output module 235 can be operable, for example, to transmit audio data to an output device, such as a set of headphones, a peripheral device, or a graphical user interface, for example, which can optionally be supported by a separate video display module 240, or the display can be supported with one or more other output devices by the output module 235.

The CPU on a handheld computer system can have difficulties concurrently processing the audio data files described herein. In some embodiments, a handheld computing system may have latency difficulties when concurrently processing more than 2 audio data files. As such, data files may require compression. In some embodiments, the data files can be compressed using a compression technique, for example, such as QUICKTIME by Apple. Other file compression techniques can be used. IMA4 can also be used to compress the files in some embodiments. In some embodiments, the system requires at least a 600-700 MHz processor. One of skill can readily obtain peripheral devices have high processing speeds such as, for example, 2.0 GHz. The iPhone, for example, may have a 1.4 GHz processor, but it might also have a 400 MHz processor, suggesting that compressed audio data files may be needed for use of some embodiments of the system on the iPhone. The IMA4 compression method compresses the audio data file to about 25% of file size. An iPAD system can also be used in some embodiments.

In some embodiments, it should be appreciated, however, that the system can use pure, uncompressed wave files. Many home PCs, however, may not need compressed files due to the more powerful processors currently available for home PCs. The bandwidth of the computer system, i.e. the size of the CPU and memory will dictate whether compression is necessary. One of skill in the art will appreciate that certain compression technologies may be needed in some systems for optimum performance and that these technologies are readily identifiable and accessible.

As described above, the system can further comprise an optional data exchange module 245 embodied in a non-transitory computer readable medium, wherein the data exchange module is operable to exchange data with external computer readable media. The data exchange module 245 can, for example, serve as a messaging module operable to allow users to communicate with other users having like subject-profiles, or others users in a profile independent manner, merely upon election of the user. The users can email one another, post blogs, or have instant messaging capability for real-time communications. In some embodiments, the users have video and audio capability in the communications, wherein the system implements data streaming methods known to those of skill in the art. In some embodiments, the system is contained in a hand-held device; operable to function as a particular machine or apparatus having the additional function of telecommunications, word processing, or gaming; or operable to function as a particular machine or apparatus not having other substantial functions.

In some embodiments, the system 200 can also include a video engine (not shown) embodied in a non-transitory computer readable storage medium, wherein the video engine is operable to display input audio data and output audio data on a graphical user interface.

The system 200 can also have an output module (not shown) embodied in a non-transitory computer readable medium, wherein the output module is operable to (i) transmit the audio data and video data to an output device. Moreover, the system 200 can include a user control interface 270.

The systems taught herein can be practiced with a variety of system configurations, including personal computers, multiprocessor systems, microprocessor-based or programmable consumer electronics, network PCs, minicomputers, mainframe computers, and the like. The teachings provided herein can also be practiced in distributed computing environments where tasks are performed by remote processing devices that are linked through a communications network. As such, in some embodiments, the system further comprises an external computer connection through the data exchange module 245 and a browser program module (not shown). The browser program module (not shown) can be operable to access external data as a part of the data exchange module 245.

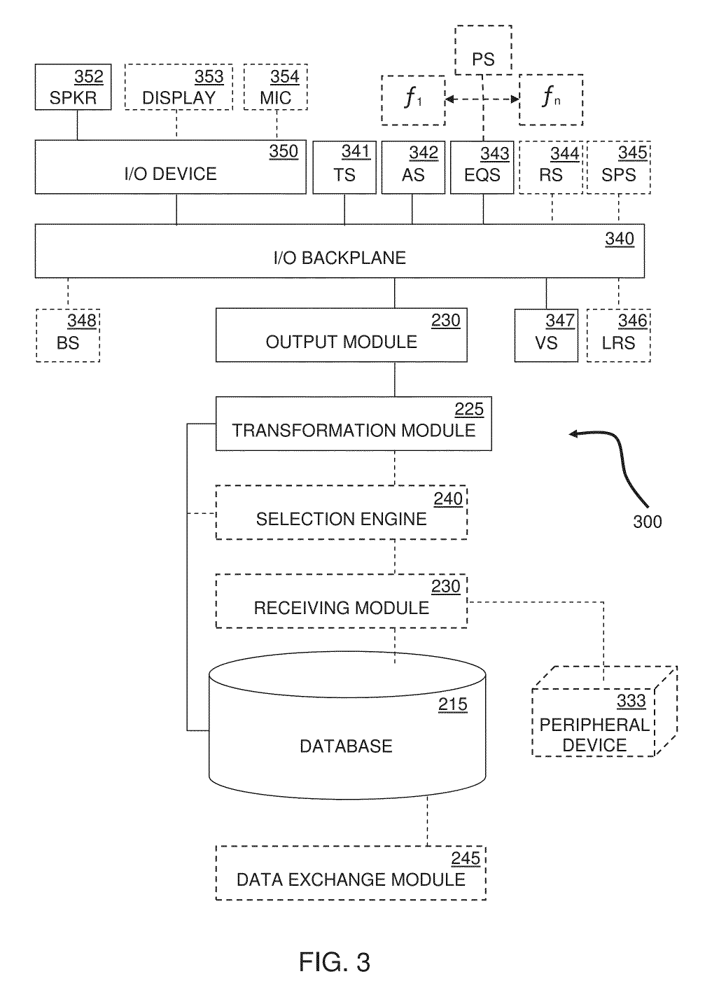

FIG. 3 is a concept diagram illustrating the system, according to some embodiments. The system 300 contains components that can be used in a typical embodiment. In addition to the database 215, the transformation module 225, and the output module 230 shown in FIG. 2, the memory of the device 300 also includes a data exchange module 245 and the browser program module (not shown) for accessing the external data. The system can also have a receiving module 235 on a non-transitory computer readable medium for receiving a set of user-selected output audio instructions from a peripheral device, the receiving module 235 operably connected to the database for storing the set of user-selected output audio instructions. The instructions can be received, for example, through a port for connecting a peripheral device 333 to the computer to receive the set of user-selected output audio instructions from the peripheral device 333. The system can also have a selection engine 240 on a non-transitory computer readable storage medium for selecting a set of output audio instructions from a plurality of sets of output audio instructions. The system can also have a speaker 352, display 353, and microphone 354 connected directly or through I/O device 350, which is connected to I/O backplane 340.

The system 300 can be implemented in a stand-alone device, a computer system, or network. In FIG. 3, for example, the I/O device 350 connects to the speaker 352, display 353, and microphone 354, but could also be coupled to other features. Such a device can have a variety of state selectors such as, for example, a transformation state selector (TS) 341, an amplifier state selector (AS) 342, an equalizer state selector (EQS) 343, a reverb state selector (RS) 344, a special virtualization state selector (SPS) 345, a bass state selector (BS) 348, a volume state selector (VS) 347, and a balance (LRS) state selector with each state selector connected directly to the I/O backplane 340.

In some embodiments, the system further comprises security measures to protect the subject's privacy, integrity of data, or both. Such security measures are those well-known in the art such as firewalls, data encryption, anti-spy software, and the like. In addition, the system can be configured for use in an environment that requires administrative procedures and control. For example, the system can include an administrative module (not shown) operable to control access, configure the engines, monitor results, perform quality assurance tests, and define audiences for targeting and trending. The security measures allow the systems and methods taught herein to be safely used in a network environment.

In some embodiments, the system is a web enabled application and can use, for example, Hypertext Transfer Protocol (HTTP) and Hypertext Transfer Protocol over Secure Socket Layer (HTTPS). These protocols provide a rich experience for the end user by utilizing web 2.0 technologies, such as AJAX, Macromedia Flash, etc. In some embodiments, the system is compatible with Internet Browsers, such as Internet Explorer, Mozilla Firefox, Opera, Safari, etc. In some embodiments, the system is compatible with mobile devices having full HTTP/HTTPS support, such as iPhone, PocketPCs, Microsoft Surface, Video Gaming Consoles, and the like. In some embodiments, the system can be accessed using a Wireless Application Protocol (WAP). This protocol will serve the non HTTP enabled mobile devices, such as Cell Phones, BlackBerries, Droids, etc., and provides a simple interface. Due to protocol limitations, the Flash animations are disabled and replaced with Text/Graphic menus. In some embodiments, the system can be accessed using a Simple Object Access Protocol (SOAP) and Extensible Markup Language (XML). By exposing the data via SOAP and XML, the system provides flexibility for third party and customized applications to query and interact with the system's core databases. For example, custom applications could be developed to run natively on iPhones, Java or .Net-enabled platforms, etc. One of skill will appreciate that the system is not limited to any of the platforms discussed above and will be amenable to new platforms as they develop.

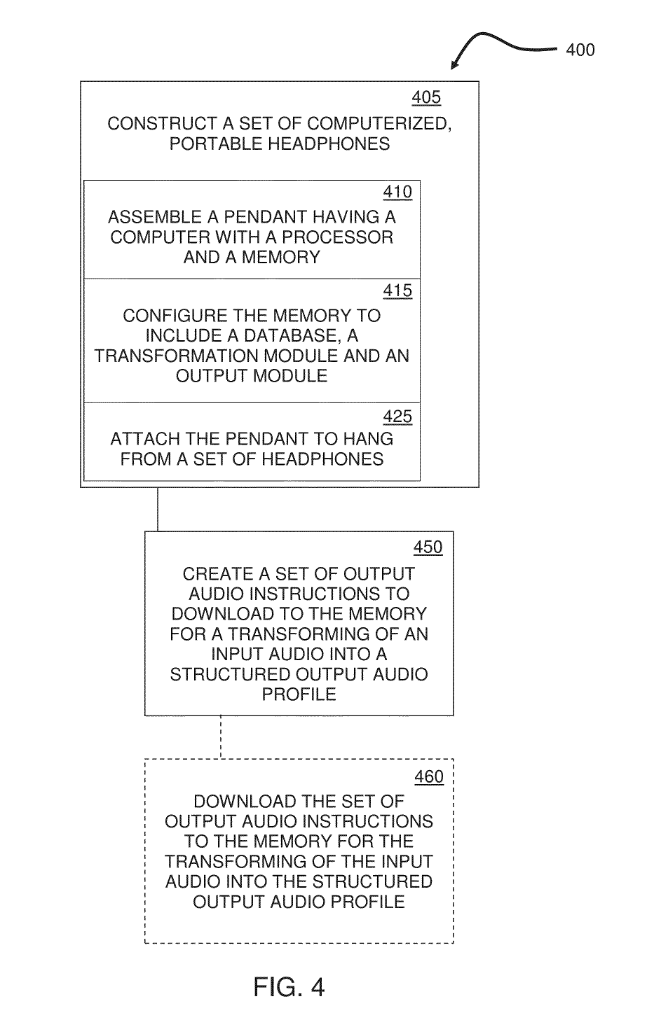

FIG. 4 illustrates a method for constructing a set of computerized, headphones, according to some embodiments. One of skill can construct 405 a computerized set of headphones, for example, as follows: assemble 410 a pendant having a computer with a processor and a memory for a transforming of an input audio data set into a structured output audio profile having a preselected distribution of relative audio amplitudes over a corresponding set of audio frequencies; configure 415 the memory to include a database, a transformation module, and an output module; and, attach 425 the pendant to hang from the set of headphones. Since the headphones can be configured with a left ear speaker and a right ear speaker, in some embodiments, the pendant can be operably attached to hang from the right ear speaker and the left ear speaker. The database is on a non-transitory computer readable medium for storing a set of output audio instructions which are configured for the transforming of the input audio data set into the structured output audio profile. As such, one can also create 450 the set of output audio instructions as a step in the method of constructing the set of computerized headphones, and these instructions can then be downloaded 460 to the memory of the computer, e.g., to the database.

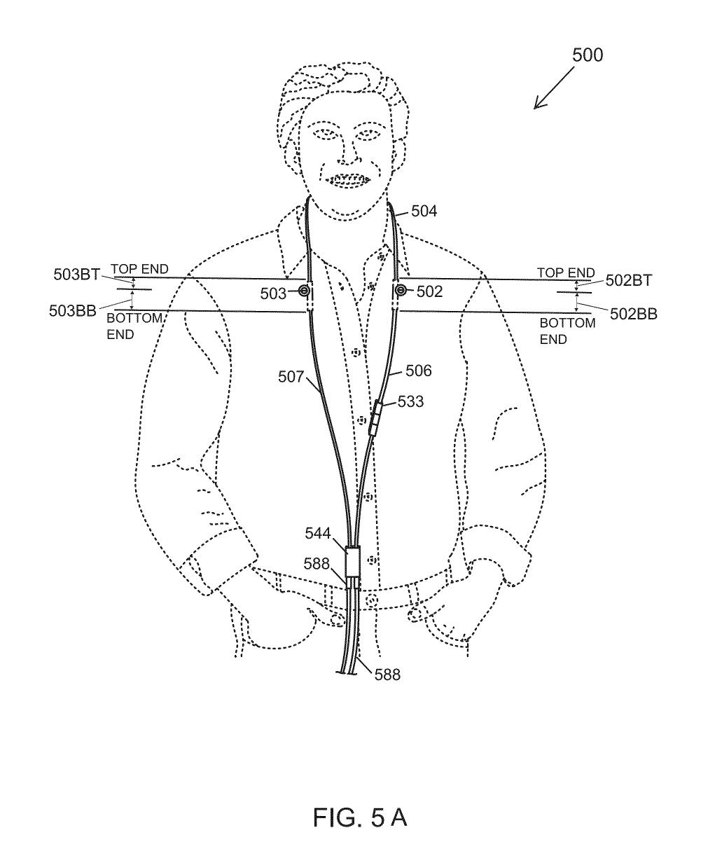

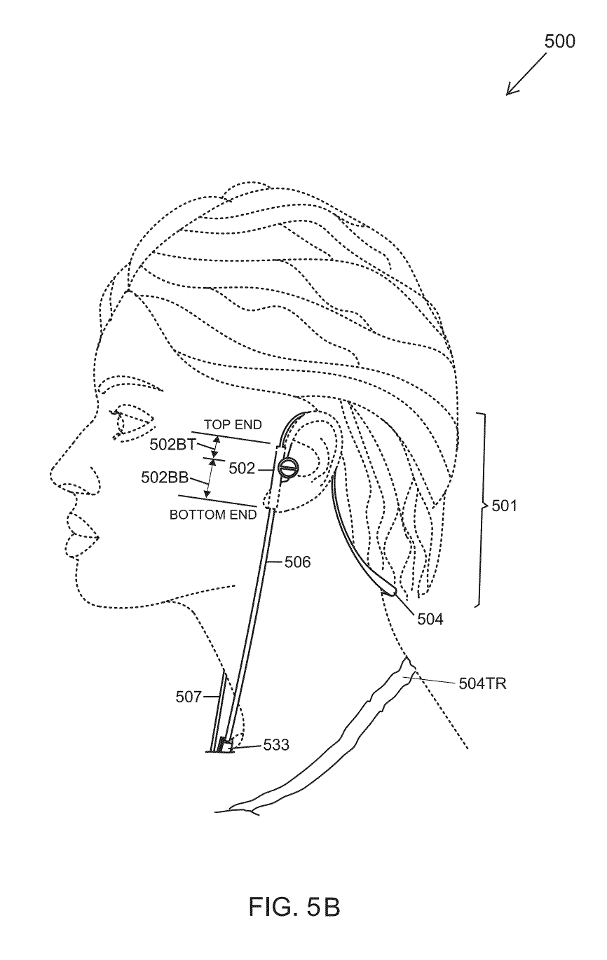

FIGS. 5A and 5B illustrate a set of computerized, headphones in use, according to some embodiments. One of skill will appreciate that the configurations of the systems taught herein provide ease of carrying, comfort, and/or use of headphones, particularly portable headphones. FIG. 5A illustrates a computerized, portable headphone system 500 on a user. The system can comprise a set of headphones 502,503 having a left ear speaker 502 operably attached to a left cable brace 502BT,502BB with a top-end and bottom-end and a right ear speaker 503 operably attached to a right cable brace 503BT,503BB with a top-end and a bottom-end. The system can also include a neckstrap 504 having a left-end operably attached to the top-end of the left cable brace 502BT and a right-end operably attached to the top-end of the right cable brace 503BT. A computerized pendant 544 can be operably attached to the headphones 502,503, the pendant 544 being configured for hanging ventrally below a user's chin during use. The computerized pendant 544 can be configured with a computer having a processor and a memory operably connected to the processor for a transforming of an input audio data set. And, the pendant 544 can also include an energy source in an operable connection with the computer. One of skill will appreciate that a battery of the proper size and energy output can be used. In some embodiments, the battery is a rechargeable battery. And, in some embodiments, the battery is easily replaced by a user of the system using a disposable battery, for example. In order to connect the headphones 502,503 with the pendant 544, the systems can include a left cable 506 operably connecting the output module of the computer to the left ear speaker 502 through the bottom of the left cable brace 502BB; and, a right cable cable 507 operably connecting the output module of the computer to the right ear speaker 503 through the bottom of the right cable brace 503BB. The bottom of the cable braces or “beams” 502BB,503BB can be used to direct a flow of each respective cable, the left cable 506 and the right cable cable 507, up the front of each respective ear during use; whereas, the top of the cable braces or “beams” 502BT, 503BT to direct a flow of the left and right ends of the neck strap 504 over each respective ear during use. Pendant 544 can then be connected to an audio source (not shown) through an audio cable 588.

In some embodiments, the system can contain state selectors that can be activated by touch control or voice control. In some embodiments, the state selectors can be on a control switch 533 that is operably connected between the headphones 502,503 and the pendant 544, and the control switch can be activated by touch control and/or voice control. In some embodiments, the pendant 544 can contain state selectors that can be activated by touch control and/or voice control. In these embodiments, the state selectors can include, but are not limited to, an on/off state selector to engage or disengage the transformation module, an amplifier state selector to engage or disengage an amplifier circuit, and/or a output audio profile state selector for a selecting of a set of output audio instructions from a plurality of sets of output audio instructions.

And, in some embodiments, it should be appreciated that a user may benefit from a tension-relief strap 544TR or a clothing fastener (not shown), such as a clothing clamp, to alleviate a portion of the force applied to the user's ears during use of the headphone system. In some embodiments, the tension relief strap, or the clothing clamp, can fasten to the pendant and circumscribe around the posterior neck of the user. And, in some embodiments, the tension-relief strap 544TR can be an adjustable cord that can be adjusted for length for a desired positioning of the pendant by a user using any of a variety of known adjustment means known to one of skill. In some embodiments, the adjustment means can include any such means known to one of skill, for example, side-release buckles, center-release buckles, slides, loops, strap adjusters, cord locks, cord adjusters, D-rings, See, for example, www.strapworks.com (downloaded Jun. 16, 2014) for adjustment means, each of which is hereby incorporated herein by reference in it's entirety. Likewise, the clothing fastener can be any such fastener known to one of skill, for example, the type of clamp or clip, such as a spring-loaded tension clamp, at least similar to that which is used to mount a microphone or a badge to a shirt. And, in some embodiments, the pendant can have a belt clip, or belt loop, to relieve a portion of the force applied to the user's ears during use of the headphone system. One of skill will appreciate that any style of strap, clothing clamp, belt clip, or belt loop can be fastened to the back of the pendant 544 to serve this purpose.

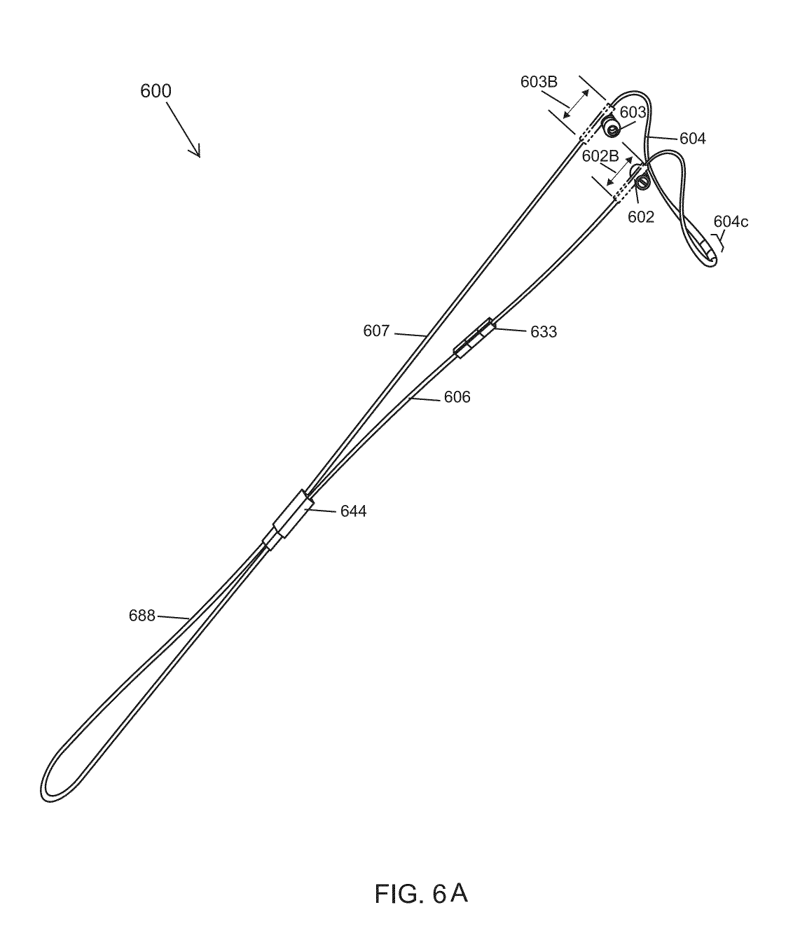

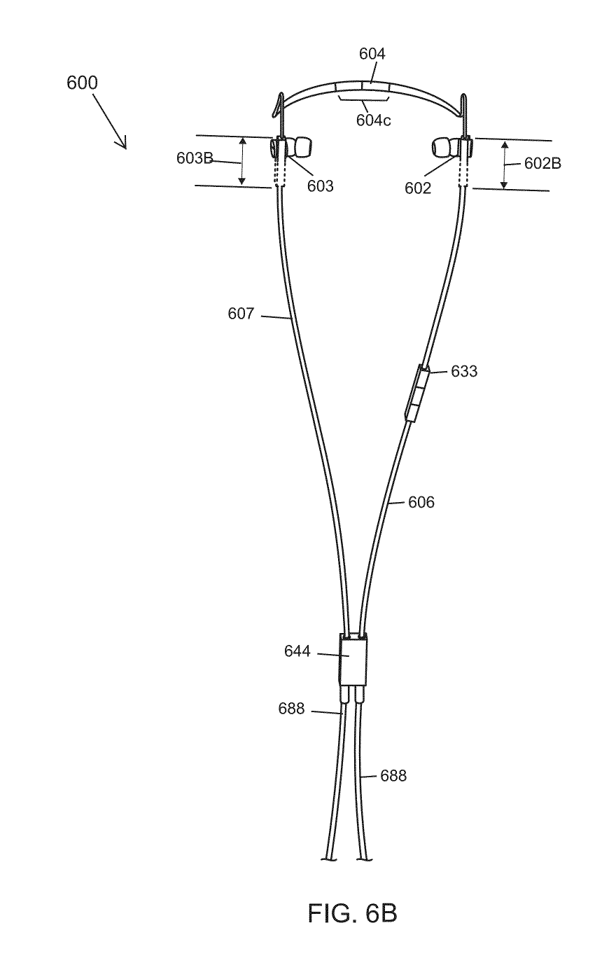

FIGS. 6A and 6B illustrate a set of computerized, headphones in a front perspective view and frontal view, according to some embodiments. FIG. 6A illustrates a computerized, portable headphone system 600. The system can comprise a set of headphones 602,603 having a left ear speaker 602 operably attached to a left cable brace 602B with a top-end and bottom-end and a right ear speaker 603 operably attached to a right cable brace 603B. The system can also include a neckstrap 604 having a left-end operably attached to the top-end of the left cable brace 602B and a right-end operably attached to the top-end of the right cable brace 603B. A computerized pendant 644 can be operably attached to the headphones 602,603, the pendant 644 being configured for hanging ventrally below a user's chin during use. The computerized pendant 644 can be configured to contain a computer having a processor and a memory operably connected to the processor for a transforming of an input audio data set.

It should be appreciated that, in some embodiments, the neckstrap can have a connector that releases upon application of a stress that exceeds normal stresses during use of the device, as a safety consideration. In some embodiments, the releasable connector can be considered a “safety, breakaway” connector 604c. Structural means for such safety, breakaway connectors can be found at http://www.umei.com/lanyards.htm#LY411 which is hereby incorporated by reference in it's entirety. Such safety, breakaway connectors 604c can be metal or non-metal, including plastic or textile materials. In some embodiments, the breakaway connector 604c can be any such connector known to those of skill including, but not limited to, a snap connector; hook-and-latch; hook-and-loop (e.g., VELCRO); metal ball/chain breakaway; breakaway rubber tube with any combination of male and female connectors having any level of friction such as smooth, rough, or interlocking; breakaway safety buckle; safety breakaway hinge connector; and the like.

The pendant 644 can also include an energy source in an operable connection with the computer. One of skill will appreciate that a battery of the proper size and energy output can be used. In some embodiments, the battery is a rechargeable battery. And, in some embodiments, the battery is easily replaced by a user of the system using a disposable battery, for example.

In order to connect the headphones 602,603 with the pendant 644, the system 600 can include a left cable 606 operably connecting the output module of the computer to the left ear speaker 602 through the bottom of the left cable brace 602B; and, a right cable 607 operably connecting the output module of the computer to the right ear speaker 603 through the bottom of the right cable brace 603B. Pendant 644 can then be connected to an audio source (not shown) through an audio cable 688. A port (not shown) can be added to the pendant 644, to facilitate transmission of data to and from the pendant 644. One of skill will appreciate that any suitable port can be used such as, for example, any universal serial bus (USB) port including, but not limited to, a micro-USB. In some embodiments, the port can be configured to mate with a lightening-to-USB type connector used by APPLE, such as that found on a USB 2.0 cable.

It should be appreciated that the computerized pendant can have any shape or size that one of skill can configure as operational for at least one of the functions taught herein. In some embodiments, the size of the pendant can be based on the size of the battery, or battery type, needed to power the device for at least a minimal amount of time. In some embodiments, the battery can be of a size or type that can power the device for at least 4 hrs, at least 6 hrs, at least 8 hrs, at least 10 hrs, at least 12 hrs, at least 14 hrs, at least 16 hrs, at least 18 hrs, at least 20 hrs, at least 22 hrs, at least 24 hrs, or any amount of time therein in increments of 1 hour. As such, the thickness of the computerized pendant can range from about 3 mm to about 15 mm, from about 4 mm to about 12 mm, from about 5 mm to about 10 mm, from about 6 mm to about 9 mm, from about 7 mm to about 8 mm, or any range therein in increments of 0.5 mm. Likewise, the thickness of the computerized pendant can be about 3 mm, about 4 mm, about 5 mm, about 6 mm, about 7 mm, about 7.5 mm, about 8 mm, about 9 mm, about 10 mm, about 11 mm, about 12 mm, about 13 mm, about 14 mm, about 15 mm, about 16 mm about 17 mm, about 18 mm, or any amount therein. Moreover, in some embodiments, the width of the computerized pendant can range from about 10 mm to about 60 mm, from about 12 mm to about 55 mm, from about 14 mm to about 50 mm, from about 16 mm to about 45 mm, from about 18 mm to about 40 mm, about 30 mm, or any range therein in increments of 1.0 mm. Likewise, the width of the computerized pendant can be about 12 mm, about 14 mm, about 16 mm, about 18 mm, about 20 mm, about 22 mm, about 24 mm, about 26 mm, about 28 mm, about 30 mm, about 32 mm, about 34 mm, about 36 mm, about 38 mm, about 40 mm, about 42 mm, about 44 mm, about 46 mm, about 48 mm, about 50 mm, about 52 mm, about 54 mm, about 56 mm, about 58 mm, about 60 mm, about 60 mm, or any amount therein in increments of 1.0 mm. Moreover, in some embodiments, the length of the computerized pendant can range from about 20 mm to about 80 mm, from about 22 mm to about 75 mm, from about 24 mm to about 70 mm, from about 26 mm to about 65 mm, from about 30 mm to about 60 mm, about 62 mm, or any range therein in increments of 1.0 mm. Likewise, the length of the computerized pendant can be about 20 mm, about 22 mm, about 24 mm, about 26 mm, about 28 mm, about 30 mm, about 32 mm, about 34 mm, about 36 mm, about 38 mm, about 40 mm, about 42 mm, about 44 mm, about 46 mm, about 48 mm, about 50 mm, about 52 mm, about 54 mm, about 56 mm, about 58 mm, about 60 mm, about 62 mm, about 64 mm, about 66 mm, about 68 mm, about 70 mm, or any amount therein in increments of 1.0 mm. In some embodiments, the computerized pendant can have dimensions that are greater than or equal to the following thickness:width:length dimensions in mm: 4:14:30, +/−5 mm for each dimension. In some embodiments, the computerized pendant can have dimensions that are less than or equal to the following thickness:width:length dimensions in mm: 12:50:70, +/−5 mm for each dimension. In some embodiments, the computerized pendant can have dimensions that are the following thickness:width:length dimensions in mm: 7.5:30:62, +/−5 mm for each dimension. In some embodiments, the computerized pendant can have a volume ranging from about 1500 mm³ to about 45,000 mm³, from about 2000 mm³ to about 40,000 mm³, from about 2500 mm³ to about 35,000 mm³, from about 3000 mm³ to about 30,000 mm³, from about 3500 mm³ to about 25,000 mm³, from about 4000 mm³ to about 20,000 mm³, from about 4500 mm³ to about 15,000 mm³, from about 5000 mm³ to about 10,000 mm³, from about 1500 mm³ to about 15,000 mm³, from about 1500 mm³ to about 10,000 mm³, from about 1500 mm³ to about 5,000 mm³, or any range there in increments of 500 mm³.

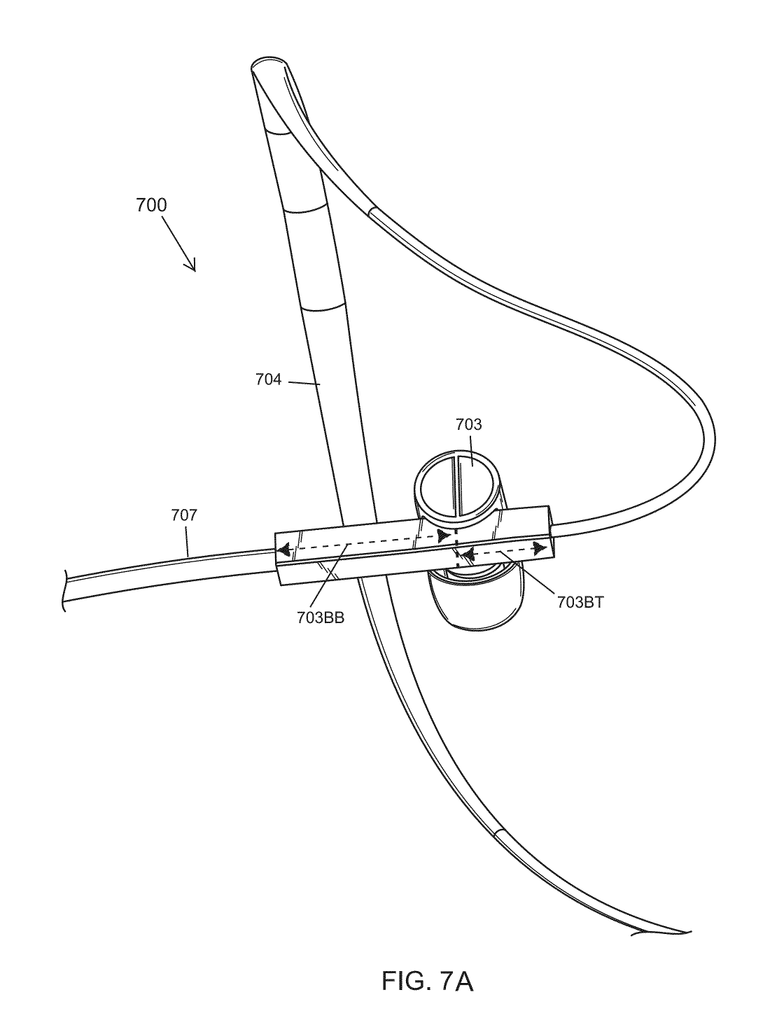

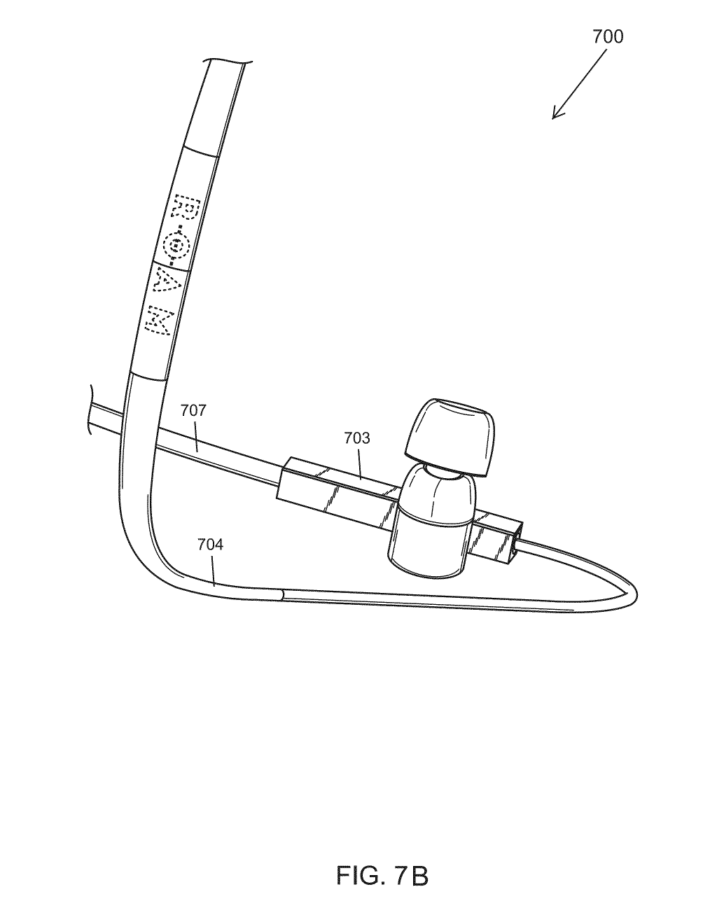

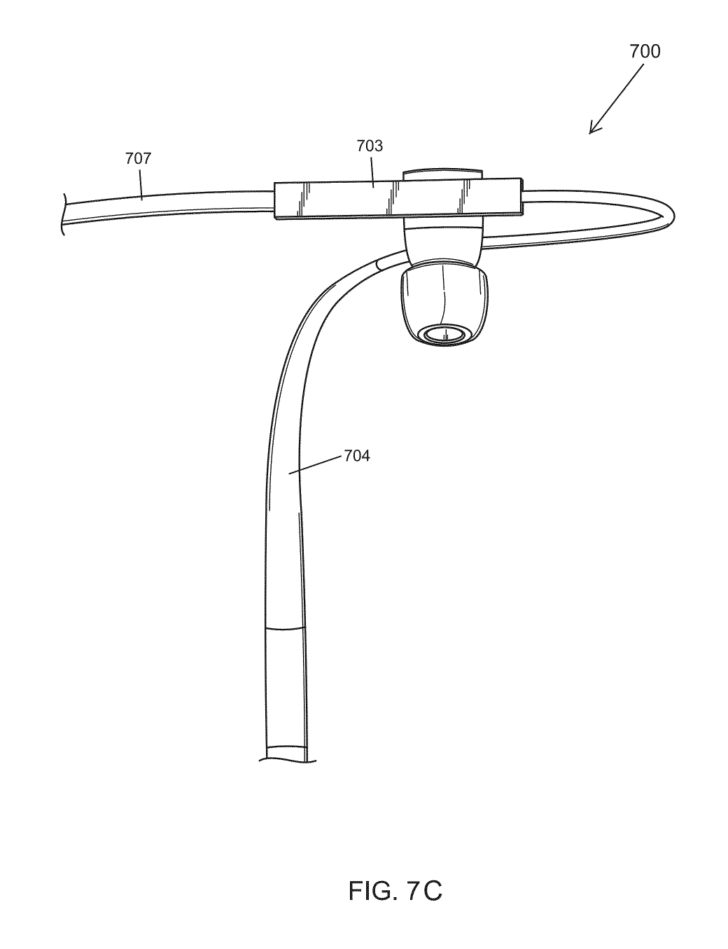

FIGS. 7A-7C illustrate an enlarged view of a set of computerized, headphones taught herein having an earbud having a cuboidal beam having a top portion with a length that is shorter than the bottom portion in a side-frontal perspective view, a rear view, and a frontal perspective view, according to some embodiments (left ear speaker is not shown but mirrors the right ear speaker). One of skill will appreciate the functionality of the headphone design, which provides comfort and specificity of the left ear speaker to the left ear, and the right ear speaker 703 to the right ear. In some embodiments, the left ear speaker is operably attached posterior to the left cable brace and the right ear speaker 703 is operably attached posterior to the right cable brace. In some embodiments, the left cable brace (not shown but mirrors the right cable brace) is a structural beam and the right cable brace 703BB,703BT is a structural beam. The left cable brace (not shown but mirrors the right cable brace) can be a structural beam having a top portion with a length that is shorter than the bottom portion and the right cable brace 703BB,703BT can be a structural beam having a top portion 703BT with a length that is shorter than the bottom portion 703BB. In some embodiments, the left cable brace (not shown) is a cuboidal beam and the right cable brace 703BB,703BT is a cuboidal beam. The left cable brace (not shown) can be a cuboidal beam having a top portion with a length that is shorter than the bottom portion and the right cable brace 703BB,703BT can be a cuboidal beam having a top portion 703BT with a length that is shorter than the bottom portion 703BB.

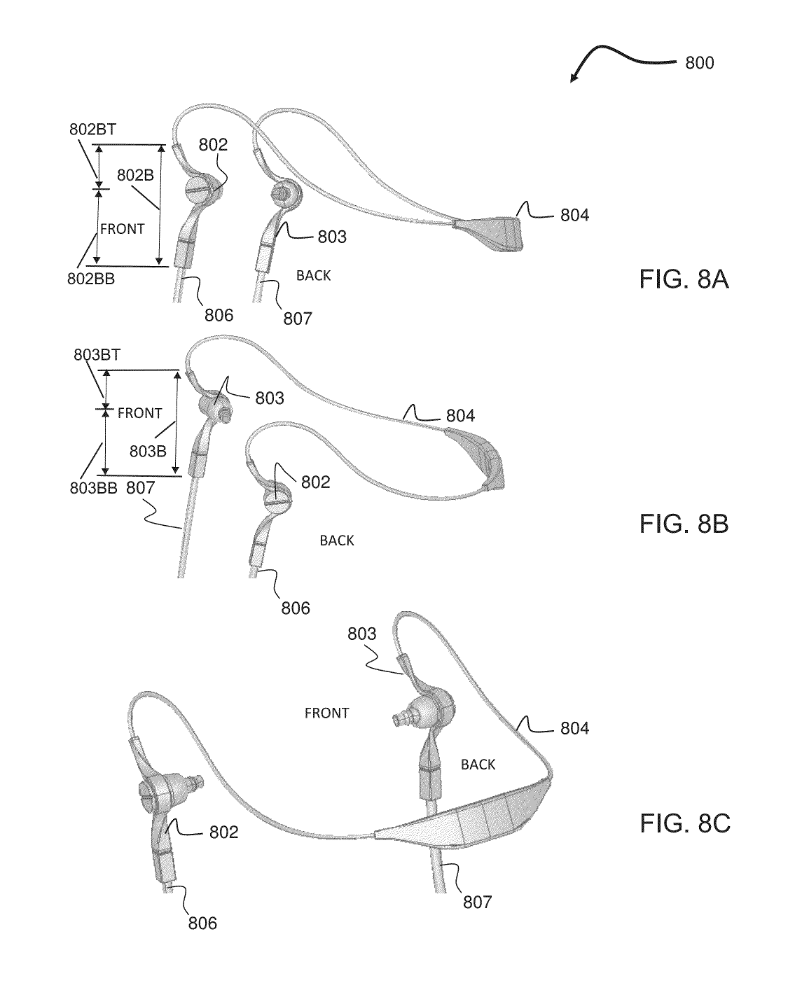

FIGS. 8A-8C illustrate an enlarged view of a set of computerized, headphones taught herein with an earbud having a twisted beam having a top portion with a length that is shorter than the bottom portion in a frontal perspective view, rear perspective view, and a top-frontal perspective view, according to some embodiments. As shown by comparing FIGS. 7 and 8, one of skill will also appreciate that the braces and beams can vary significantly in aesthetic appearance, having a vast array of possible aesthetic configurations, while providing the same functionality. As such, the braces and beams can provide an aesthetic appeal in addition to functionality. In some embodiments, for example, the left cable brace 802B is a twisted beam and the right cable brace 803B is a twisted beam. The left cable brace 802B can be a twisted beam having a top portion 802BT with a length that is shorter than the bottom portion 802BB and the right cable brace 803 can be a twisted beam having a top portion 803BT with a length that is shorter than the bottom portion 803BB. The system can also include a neckstrap 804 having a left-end operably attached to the top-end of the left cable brace 802BT,802BB and a right-end operably attached to the top-end of the right cable brace 803BT,803BB. A computerized pendant (not shown) can be operably attached to the headphones 802,803, the pendant (not shown) being configured for hanging ventrally below a user's chin during use. The computerized pendant (not shown) can be configured to contain a computer having a processor and a memory operably connected to the processor for a transforming of an input audio data set.

The pendant can contain state selectors on a control switch that can be activated by touch control. In some embodiments, the pendant can contain state selectors on a control switch that can be activated by voice control. In these embodiments, the state selectors can include, but are not limited to, an on/off state selector to engage or disengage the transformation module, an amplifier state selector to engage or disengage the amplifier circuit, and/or an output audio profile state selector for a selecting of a set of output audio instructions from a plurality of sets of output audio instructions.

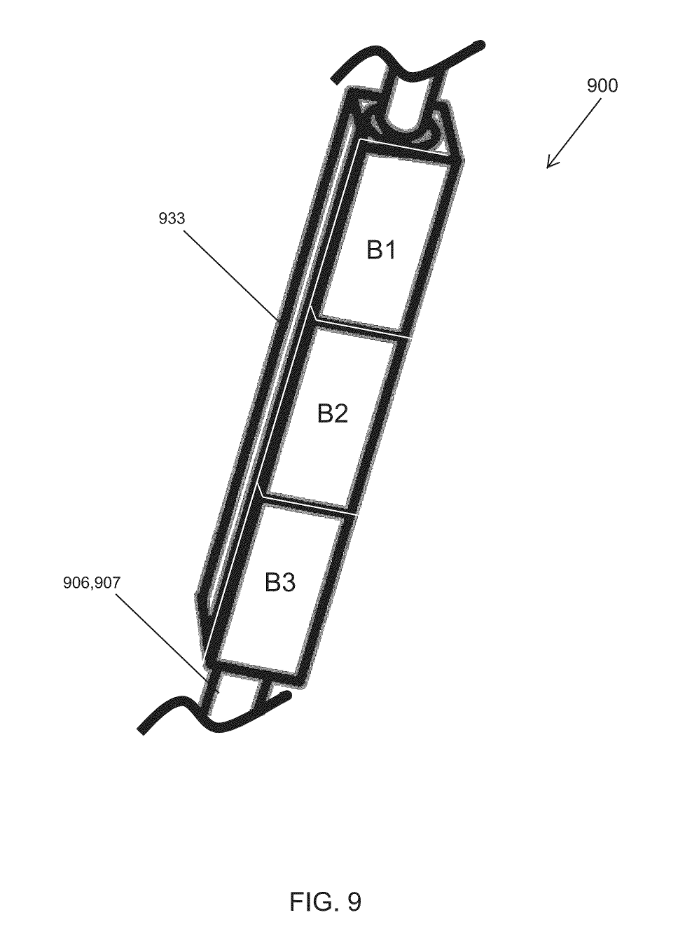

FIG. 9 illustrates a control switch with 3 buttons as state selectors, the control switch operably connected between the set of headphones and the computerized pendant, according to some embodiments. Using FIG. 5 merely as a reference example of other components of the system, the system 900 can have a control switch 933 operably connected between the set of headphones 502,503 and the computerized pendant 544 in the left cable 506 or the right cable 507, the control switch 533 having a state selector B1,B2,B3. In some embodiments, the state selector B1 can be used for an engaging, or a disengaging, of the transforming of the input audio data set into the structured output audio profile. In some embodiments, the state selector B2 can be used for an engaging, or a disengaging, of the amplifier circuit. And, in some embodiments, the state selector B3 can be used for a selecting of a set of output audio instructions from a plurality of sets of output audio instructions.

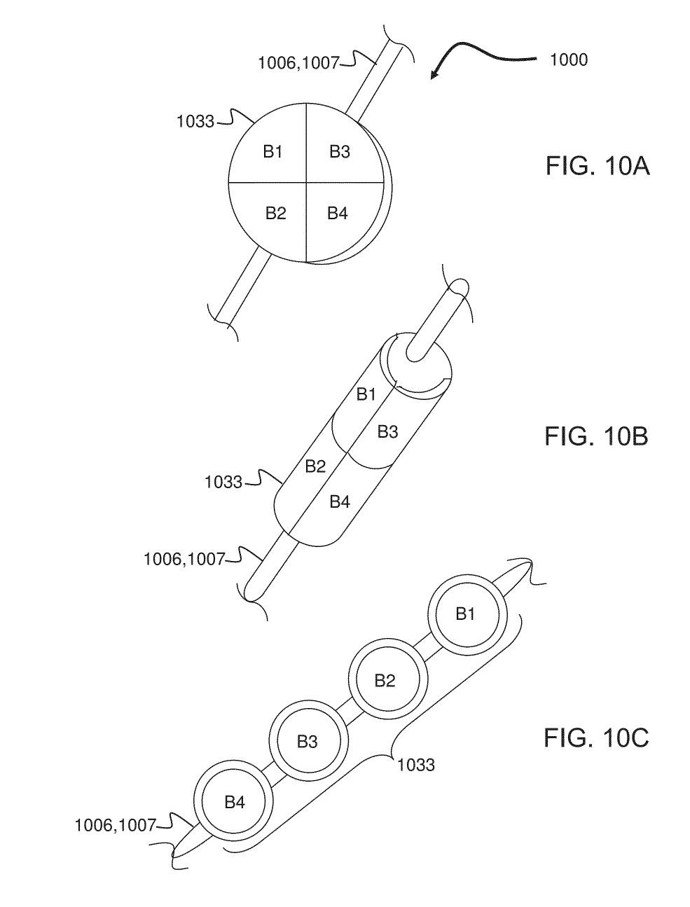

FIGS. 10A-10C illustrate a variety of control switches with 4 buttons as state selectors, each of the control switches operably connected between the set of headphones and the computerized pendant according to some embodiments. One of skill will appreciate that the control switch 1033 can have virtually any configuration contemplated. FIG. 10A, for example, shows a circular disc switch 1033 having 4 buttons B1,B2,B3,B4 operably connected in a left cable 1006 or a right cable 1007 between a set of headphones (not shown) and a computerized pendant (not shown). FIG. 10B, for example, shows a circular cylinder switch 1033 having 4 buttons B1,B2,B3,B4 operably connected in a left cable 1006 or a right cable 1007 between a set of headphones (not shown) and a computerized pendant (not shown). FIG. 10c, for example, shows a series of 4 circular disc switches 1033, the series providing 4 buttons B1,B2,B3,B4 operably connected in a left cable 1006 or a right cable 1007 between a set of headphones (not shown) and a computerized pendant (not shown). It should be appreciated that any number of state selectors can be incorporated into the system in the left cable 1006 or the right cable 1007 between a set of headphones (not shown) and a computerized pendant (not shown).

As described herein, the computerized pendant includes a transformation module to transform an input audio data set into a structured output audio profile. As such, a user can preselect a distribution of relative audio amplitudes over a corresponding set of audio frequencies. This can be considered an “equalizer” function provided by a system taught herein.

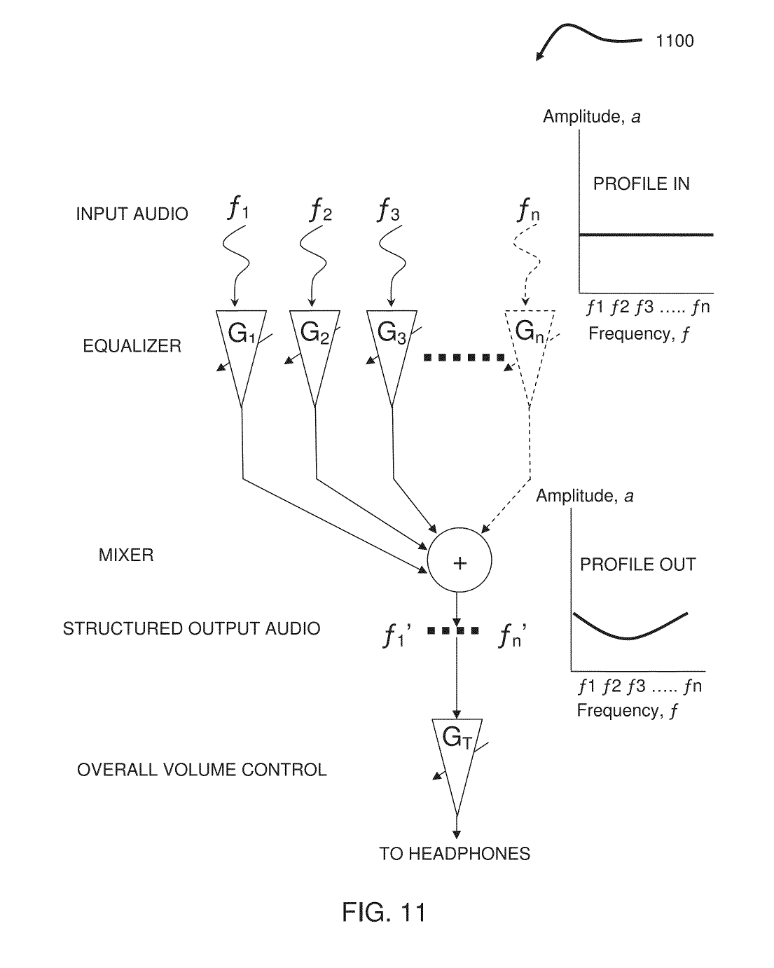

FIG. 11 illustrates a transforming of an input audio data set into a structured output audio profile using a computerized, headphone system taught herein, according to some embodiments. The transforming includes creating a structured output audio profile from the input audio data set including an audio frequency/amplitude profile with frequencies f1, f2, f3, . . . fn, where n represents the number of frequency/amplitude state selectors and can range from 2 to 20, 3 to 30, 4 to 15, or any range or amount therein in increments of 1. In some embodiments, n can be 3, 4, 5, 6, 7, 8, 9, 10, 11, or 12. One of skill will appreciate that any audio profile transformation can be made. For example, the input audio profile can have a frequency/amplitude, PROFILE IN, that is relatively flat, which is transformed by a system taught herein into an output audio profile, PROFILE OUT. The PROFILE IN is transformed into the PROFILE OUT through EQUALIZER having a gain adjuster set G1,G2,G3, . . . Gn. having any of a multitude of preselected distributions of relative audio amplitudes over a corresponding set of audio frequencies with an audio frequency/amplitude profile with frequencies f1′, f2′, f3′, . . . fn′. A user, for example, might desire a second order parabolic frequency/amplitude distribution when listening to music that the user feels benefits from increasing the amplitude of low frequencies and high frequencies relative to mid-range frequencies. The INPUT AUDIO is passed through the EQUALIZER to produce an output audio that passes through the MIXER to produce STRUCTURED OUTPUT AUDIO having a PROFILE OUT, f1′, f2′, f3′, . . . fn′. The mixed STRUCTURED OUTPUT AUDIO is then adjusted for a mixed volume by OVERALL VOLUME CONTROL using a total gain adjuster G_{T} for sending the STRUCTURED OUTPUT AUDIO to the headphones.

A frequency output level, a combination of frequency output levels, or total output level, can be controlled using any one or any combination of gain elements G1,G2,G3, . . . Gn, or G_{T} which receives an input data from the MIXER. The various gain elements can be controlled directly through user controls or through data from a controlling device such as a microprocessor.

One of skill will appreciate that there are several frequency/amplitude distributions, or audio profiles, that can obtained using the systems and methods provided herein. The music genre, or particular music within a genre, may be used to select an audio profile, where the audio profile can be selected to complement any one or any combination of blues, classical, country, dance, hip hop, jazz, metal, pop, rock, and the like. It should be appreciated that genres can overlap, and that some music may not fit within a particular genre. For at least these reasons, a user may want to design (and perhaps share) custom, or preferred, audio profiles. As such, the memory of the computer can be configured to include a database on a non-transitory computer readable medium for storing any or all of the multitude of sets of output audio instructions, each configured for the transforming of the input audio data set into a structured output audio profile. Likewise, the memory can also be configured to include a transformation module on a non-transitory computer readable medium for executing the set of output audio instructions, the executing including transforming the input audio data set into the structured output audio profile. Moreover, the memory can also be configured to include an output module on a non-transitory computer readable medium for sending the structured output audio profile to the headphones.

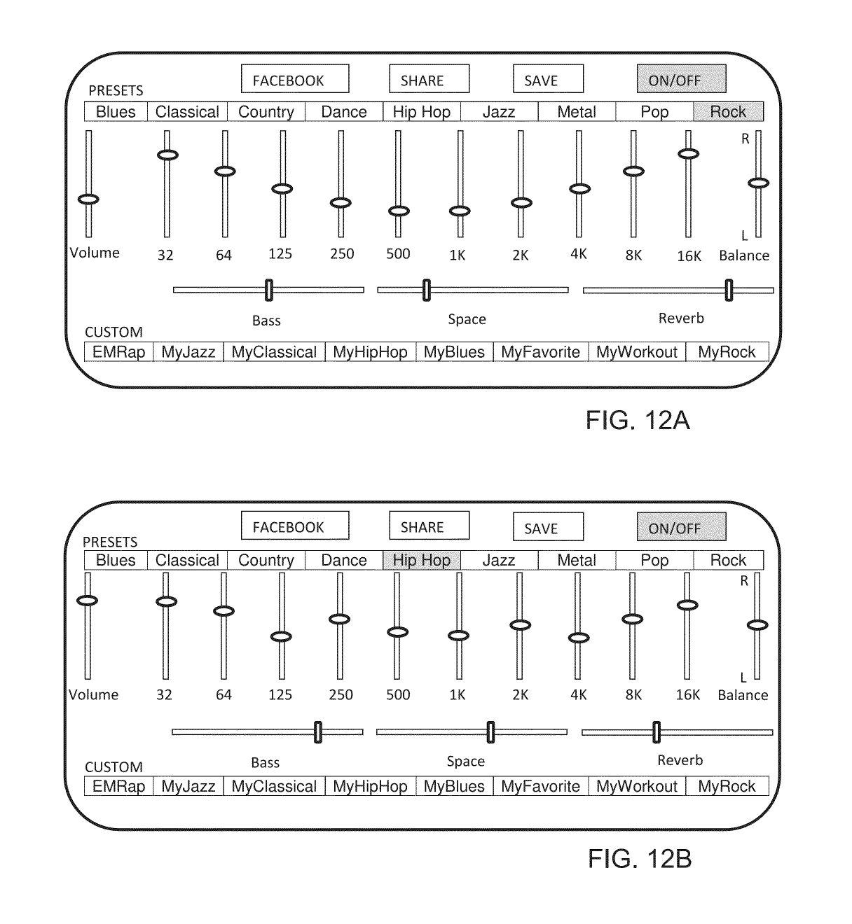

In some embodiments, the user can design and/or select output audio profiles using a peripheral computing device, each profile of which can be downloaded to the computerized pendant. And, in some embodiments, a computerized pendant provided herein can allow the user to design and/or select output audio profiles. The design and/or selection can be made using touch controls with or without a graphical user interface. FIGS. 12A and 12B illustrate screenshots of a software interface control panel with state selectors for (i) creating instructions for transforming an input audio data set into a structured output audio profile having a preselected distribution of relative audio amplitudes over a corresponding set of audio frequencies using a computerized, headphone system taught herein; (ii) accessing preset instructions; (iii) saving custom profiles; and (iv) sharing the instructions within a network community, according to some embodiments. As shown in FIGS. 12A and 12B, a user of a system taught herein may prefer one set of audio profiles for a first music genre, such as rock in FIG. 12A, and a different set of audio profiles for a second music genre, such as hip hop in FIG. 12B. Several PRESETS state selectors can be offered to provide any of several preset output audio profiles, which may include, but are not limited to, blues, classical, country, dance, hip hop, jazz, metal, pop, rock, and the like. Likewise, several CUSTOM state selectors can be provided, each of which can store a user-defined custom output audio profile that can be created and then stored by pressing the SAVE state selector, after which the user can assign a CUSTOM state selector to the creation. In addition, the CUSTOM state selectors can also store a shared output audio profile from another user, in some embodiments. Other state selectors can include, for example, volume, balance, bass, special virtualization (e.g., “Space” or “spatial”), and reverb. Moreover, instant interfacing with a social network, for example, can be obtained through a simple activation of a state selector, such as a FACEBOOK state selector in some embodiments. Likewise, the systems and methods provided herein can interface with any social network such as, perhaps, a private network through a SHARE state selector. In some embodiments, the ON/OFF state selector can be used to turn the transformation function on or off, such that a headphone system provided herein can operate without any transformation of the input audio data, or with a default transformation to achieve a default output audio profile.

The systems and methods provided herein can include an interface between a computerized, headphone system, namely a computerized pendant, and a peripheral computing device. As such, the teachings provided herein include a combination of the concepts of user-controlled sound dynamics through an equalizer function with a headphone system that alters sound dynamics directly through it's own software application without needing to control the sound dynamics at the audio source. This allows a user of the headphones to switch between audio devices while maintaining a desired set of sound dynamics in the form of preset or custom audio profiles.

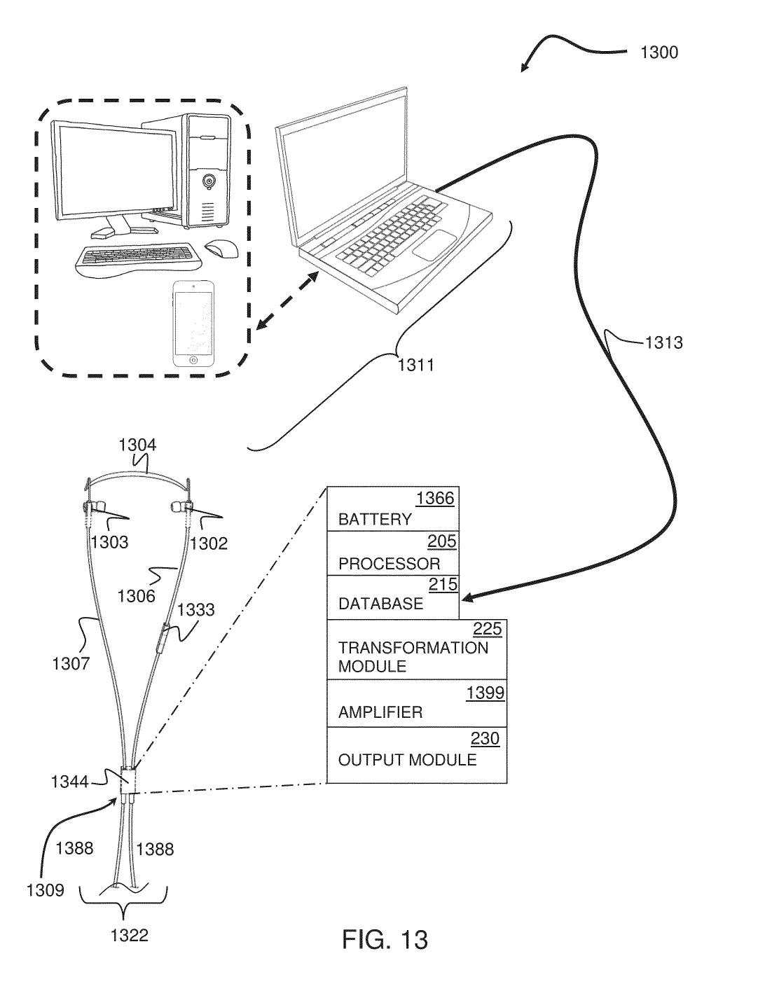

FIG. 13 illustrates an interface between a computerized, headphone system taught herein, and a peripheral computing device, according to some embodiments. The system 1300 shows how a peripheral device 1311, such as a personal computer, smartphone, or laptop, can interface with a computerized headphone system 1322. The peripheral device 1311 can download 1313 a set of output audio instructions to the computer in the pendant 1344, for example, to the database 214. The input audio data is received from an audio source through an audio cable 1388 and passes through the pendant 1344. The transformation module 225 accesses the database for a set of output audio instructions to transform a set of input audio data by executing the set of output audio instructions with the processor 205. The transformed audio data is sent to the output module 230 of the pendant 1344 for transmitting the structured output audio to a left ear speaker 1302 and a right ear speaker 1303 through a left cable 1306 and a right cable 1307. The computerized pendant requires an energy source which can be a battery 1366.

Pendants having an amplifier circuit can be used and are provided. One of skill will appreciate that the systems can benefit by the ability to amplify frequencies of the input audio data set in the transforming of the input audio data set into the structured output audio profile. In some embodiments, the pendant 1344 provides an output audio having a structured output audio profile to a sole user of the system, and the amplifier circuit 1399 provides additional power to add frequency amplitude to increase a frequency volume, for example, desired by the user. In some embodiments, the pendant 1344 provides an output audio having a structured output audio profile to two users of the system, the output audio being shared by a right cable user connected to a park/share port 1309 in the pendant having an amplifier circuit 1399 which provides additional power to add frequency amplitude as desired, or perhaps needed in some embodiments, by the two users.

In some embodiments, the pendant 1344 can contain state selectors that can be activated by touch control. In some embodiments, the pendant 1344 can contain state selectors that can be activated by voice control. In these embodiments, the state selectors can include, but are not limited to, an on/off state selector to engage or disengage the transformation module, an amplifier state selector to engage or disengage the amplifier circuit, and/or a output audio profile state selector for a selecting of a set of output audio instructions from a plurality of sets of output audio instructions.

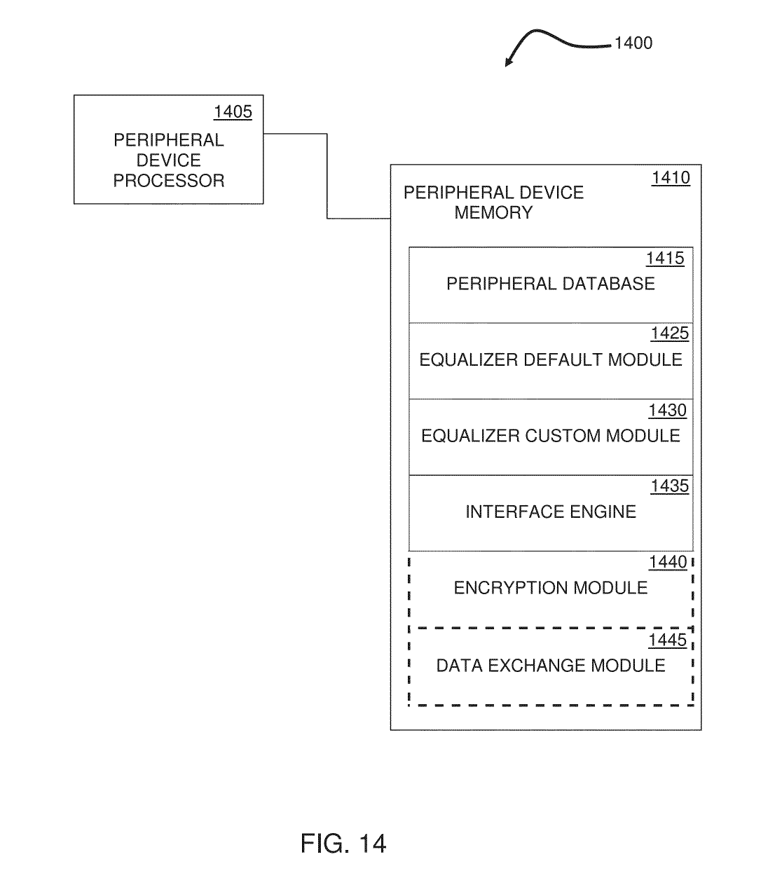

FIG. 14 illustrates a processor-memory diagram to describe components of a peripheral computer system that interfaces with a headphone system taught herein, according to some embodiments. The system 1400 shown in FIG. 14 contains a peripheral device processor 1405 and a peripheral device memory 1410 (that can include non-volatile memory), wherein the peripheral device memory 1410 includes a peripheral database 1415, an equalizer default module 1425, an equalizer custom module 1430, an interface engine 1435, as well as an optional encryption module 1440 and an optional data exchange module 1445 operable to exchange data with external computer readable media. An output module (not shown) is included to output data.

The instructions can be received, for example, through a port 1309 for connecting a peripheral device 1311 to the computer in the pendant 1344 to receive the set of user-selected output audio instructions from the peripheral device. The system 1400 can also have a selection engine (not shown) for selecting a set of output audio instructions from a plurality of sets of output audio instructions. Each of the modules and engines are on a non-transitory computer readable medium.

The system includes an input device (not shown) operable to receive audio data on a non-transitory computer readable medium. Examples of input devices include a data exchange module operable to interact with external data formats, voice-recognition software, a hand-held device in communication with the system including, but not limited to, a microphone, and the like. It should be appreciated that the input and output can be an analog or digital audio,

Through the use of a computer network, for example, the system can also be configured to interface with a cloud environment. This provides access to new software and updates on past or current software. It can offer a direct interface between the computerized pendant and the network, as well as a peripheral device. In some embodiments, the peripheral device is a hand-held device, such as a smart phone or tablet, for example, an IPHONE, IPAD, or other similar device. In some embodiments, the systems and methods can operate from the server to a user, from the user to a server, from a user to a user, from a user to a plurality of users, comparable to a system that may be used in an MMO environment (massive, multi-user environment), from a user to a server to a user, from a server to a user (or plurality of users) and a teacher (or plurality of teachers), or a server to a plurality of users and a conductor, for example. The interactions can be through real-time users, perhaps available for real-time interaction in a forum that can be either a public, private, semi-private, or member-only chat room; or, not real-time, such as a user environment including text, wavefile, and/or video communications. A blog-type environment, or message room, is an example of an environment that is not real-time.

A real-time environment provides responses to communications within set time constraints, or “deadlines”. Real-time responses, for example, can be provided on the order of milliseconds, and sometimes microseconds, ranging from 0.001 milliseconds to 999 milliseconds, from 0.01 milliseconds to 900 milliseconds, from 0.02 milliseconds to 800 milliseconds, from 0.03 milliseconds to 700 milliseconds, from 0.04 milliseconds to 600 milliseconds, from 0.05 milliseconds to 500 milliseconds, from 0.06 milliseconds to 400 milliseconds, from 0.07 milliseconds to 300 milliseconds, from 0.08 milliseconds to 200 milliseconds, from 0.09 milliseconds to 100 milliseconds, from 0.10 milliseconds to 50 milliseconds, from 1.0 milliseconds to 10 milliseconds, or any range therein in increments of 0.001 millisecond. In some embodiments, the system response occurs without perceivable delay. It should be appreciated that the network can also be configured to provide text and/or audio for real-time messaging, posting of messages, posting of instructional, posting of news or other items of a related interest to the users, and the like.

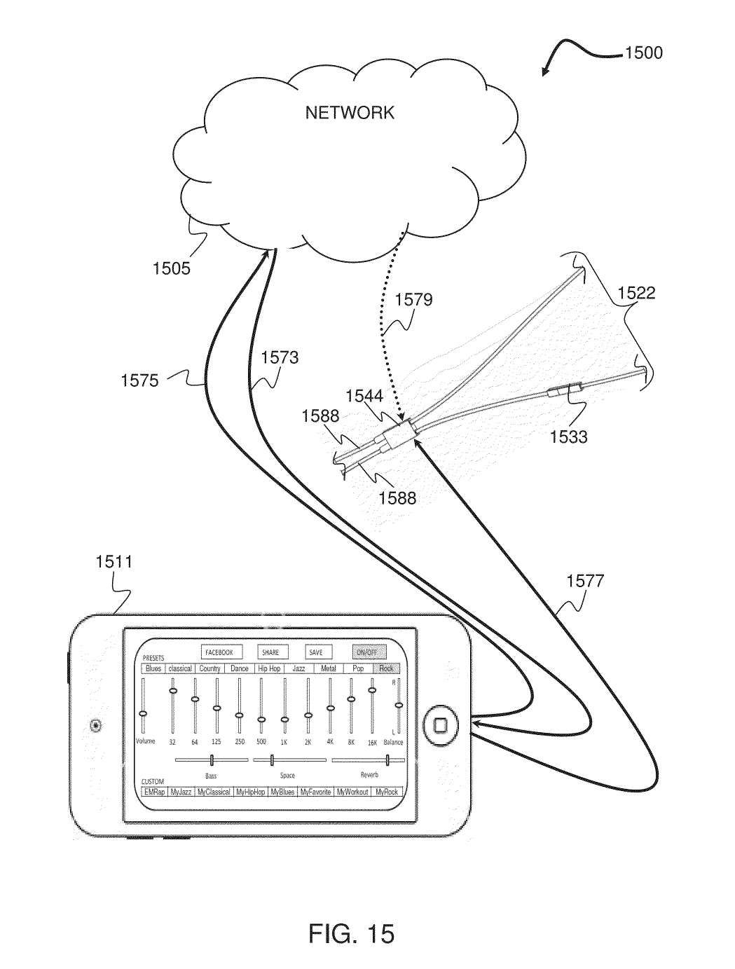

FIG. 15 illustrates an interface between a computerized, headphone system taught herein, a peripheral computing device, and a network computing system, according to some embodiments. The system 1500 includes a network 1505 that interfaces with a computerized headphone system 1522 and/or a peripheral device 1511. The peripheral device 1511 communicates with the network by uploading 1575 to the network 1505, downloading 1573 from the network 1505, and uploading 1573 to the computerized pendant 1544. The computerized pendant can also receive a download 1573 directly from the network. The uploading 1575 to the network 1505 can be done to share a set of output audio instructions, or perhaps to social network with other users. The downloading from the network can be to receive a set of output audio instructions that can be downloaded 1577 to the pendant 1544. Moreover, the peripheral device 1511 can be used to store and/or create a custom set of output audio instructions that can be downloaded 1577 to the pendant 1544. And, the peripheral device 1511, as well as the pendant 1544, can be used to store one or more sets of output audio instructions. Pendant 1544 can then be connected to an audio source (not shown) through an audio cable 1588. A port (not shown), such as a universal serial bus (e.g. micro-USB), for example, can be added to the pendant 1544, to facilitate transmission of data to and from the pendant 1544.

A user can download a set of audio instructions from a source over the internet for download onto the computerized pendant. In some embodiments, the set of audio instructions can be designed for the work of a particular artist, and perhaps even designed by the particular artist for the work. In some embodiments, the downloaded instructions can be configured to auto-execute when the computerized pendant recognizes a particular song or songs. As such, in some embodiments, the set of output audio instructions can be downloaded as a “preset” that has been configured directly for one or more songs, and the computerized pendant can be configured to execute the set of audio instructions when, for example, the selection engine 240 recognizes a streaming of data from the one or more songs. For example, in such embodiments, the selection engine can use any known means used to recognize a data stream. For example, the selection engine 240 can be configured to recognize a package of data from the song. Any digital information can be used including, but not limited to streaming audio data. The digital information can be a series of tones that are transmitted as a code, which can be a combination of one or more frequencies that are transmitted at varying time increments, as a sort of audio bar code. As such, the selection engine 240 can be configured to recognize a data tag that has been linked to the one or more songs. In such embodiments, the selection engine can be configured to initiate execution of the set of audio instructions upon recognition of such data from the one or more songs. Likewise, in some embodiments, the selection engine can be configured by a user to assign one or more sets of output audio instructions to one or more respective songs. Consistent with the above, in some embodiments, a data tag can be a means for assigning a user-selected or user-defined set of audio instructions, as desired by the user, to each of the select songs.

It is not uncommon for a listener of music to want to share the music with a second person. As such, one of skill will appreciate having a share functionality configured into the computerized pendant.

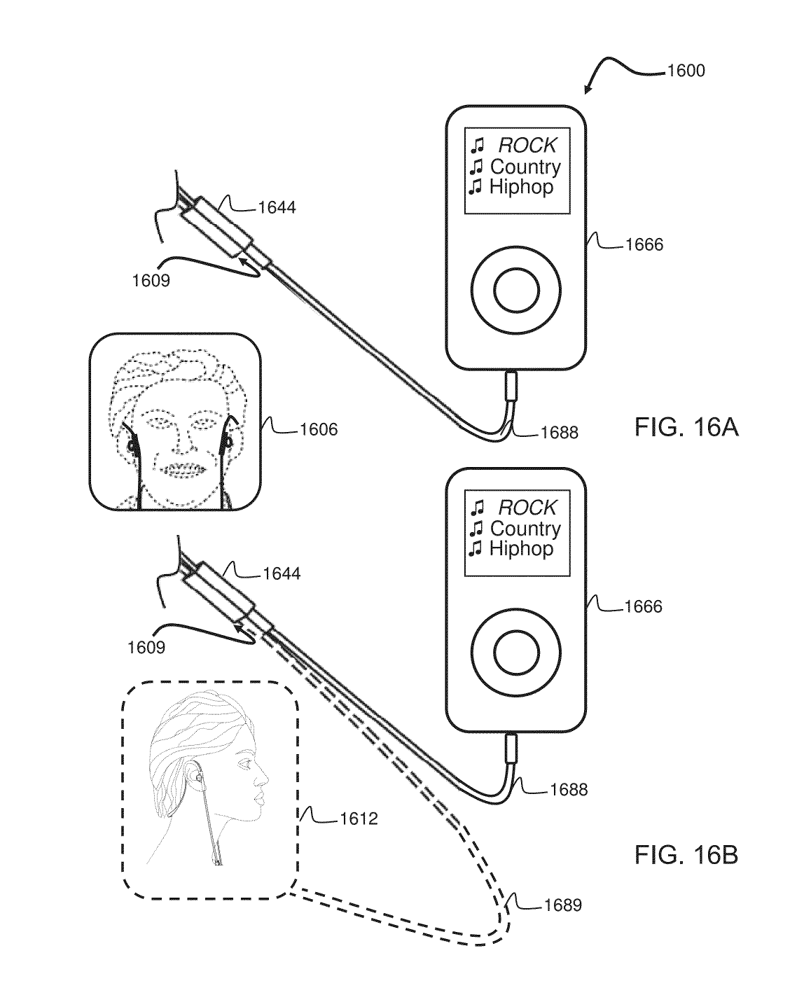

FIGS. 16A and 16B illustrate the use of a computerized, headphone system taught herein by (i) a single user or (ii) a shared use by two users at a park/share port, according to some embodiments. As shown in FIG. 16A, the computerized pendant 1644 offers a park/share port 1609 that facilitates a “parking” of the audio cable 1688 when not connected to an audio source 1666 for use by a first user 1606, as well as means for a sharing of music with a second user 1612 through a second audio cable 1689. Any audio source known to one of skill can be used. In some embodiments, the audio source is not portable, such as a desktop PC. And in some embodiments, the audio source is portable. The portable device can be any portable audio source known to one of skill such as a handheld, portable audio source. A handheld portable audio source can be, for example, an APPLE device such as, for example, an iPOD, iPHONE, iPAD, and the like.

The systems described herein can include a control switch with state selectors. The state selectors on the control switch provide the user with control over the functions executed by the computerized pendant.

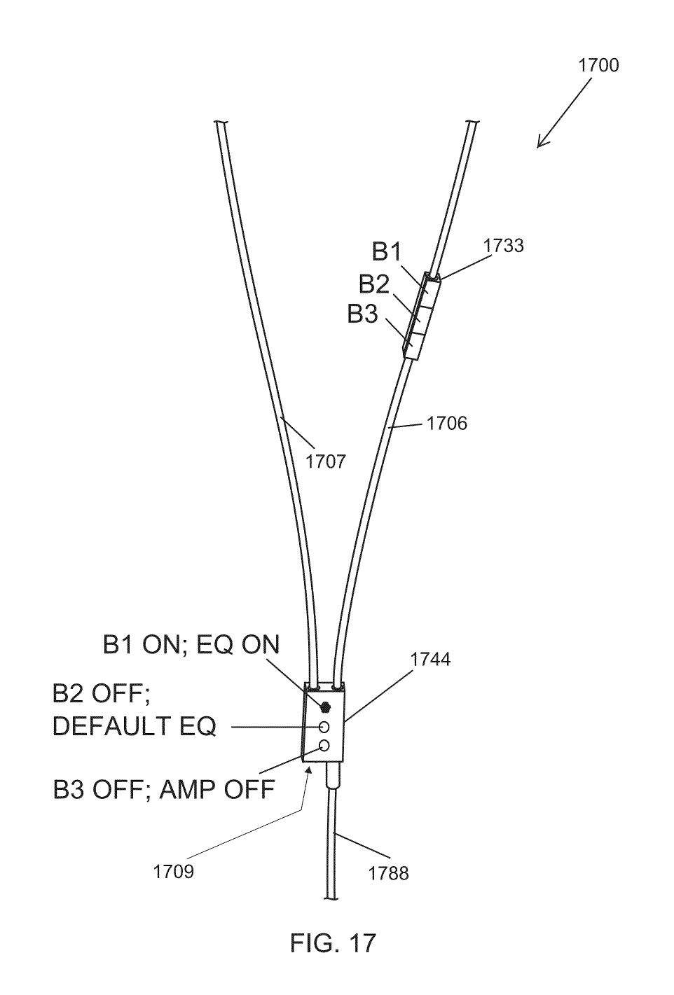

FIG. 17 illustrates a function of a control switch for a single user, the control switch having 3 buttons as state selectors and operably connected between the set of headphones and the computerized pendant, the pendant having an indicator light showing the status of each state selector, according to some embodiments. The control switch 1733 in system 1700 can turn (i) the equalizer function on/off; (ii) the default output audio instructions on/off; and (iii) the amplifier on/off through the computerized pendant. The control switch 1733 can be positioned in the left cable 1706 or the right cable 1707 between the computerized pendant 1744 and the headphones (not shown). In some embodiments, the system 1700 can be used by a single user, such that the audio cable 1788 is plugged into an audio source (not shown), and the park/share port 1709 is not being used. In such embodiments, a first state selector B1 can be turned on to activate the equalizer function EQ; a second state selector B2 can be turned off to use a default set of output audio instructions; and, a third state selector B3 can be turned off to avoid use of the amplifier, perhaps to save on battery power in the computerized pendant 1744. In some embodiments, the audio profile from the audio source can be maintained by turning off the computerized pendant 1744, for example, by pressing the first state selector B1.

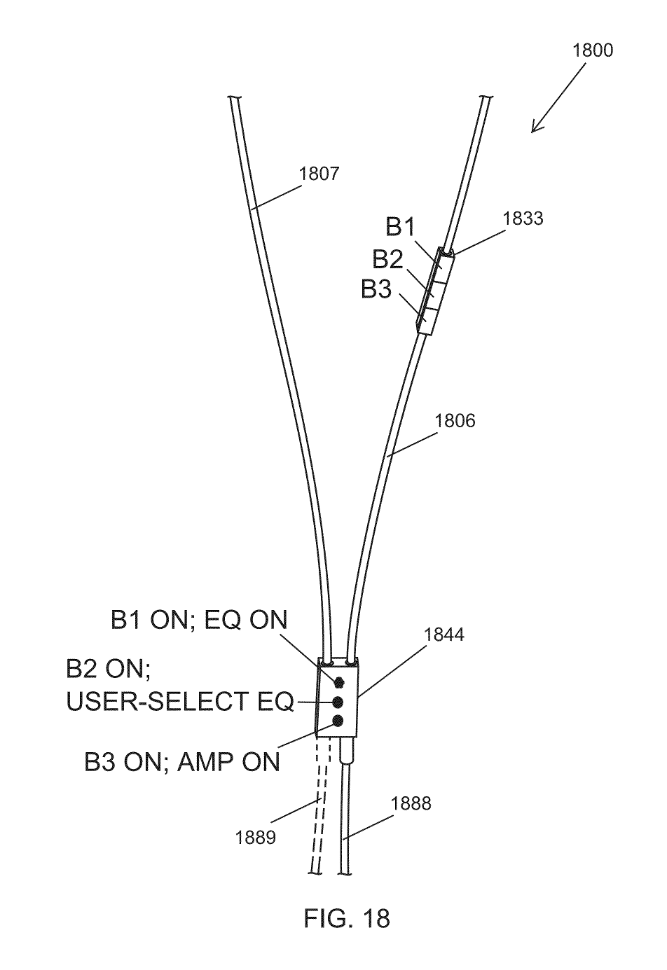

FIG. 18 illustrates a function of a control switch for a shared use of the system, the control switch having 3 buttons as state selectors and operably connected between the set of headphones and the computerized pendant, the pendant having an indicator light showing the status of each state selector, according to some embodiments. The control switch 1833 in system 1800 can turn (i) the equalizer function on/off; (ii) the default output audio instructions on/off; and (iii) the amplifier on/off through the computerized pendant. The control switch 1833 can be positioned in the left cable 1806 or the right cable 1807 between the computerized pendant 1844 and the headphones (not shown). FIG. 18 shows the system 1800 being shared between a first user and second user, such that the audio cable 1888 is plugged into an audio source (not shown), and the park/share port 1809 is being used by the second user with audio cable 1889. In such embodiments, a first state selector B1 can be turned on to activate the equalizer function EQ; a second state selector B2 can be turned on to use a user-selected or user-defined set of output audio instructions, preset or custom; and, a third state selector B3 can be turned on to use the amplifier, perhaps to boost power in the computerized pendant 1844 to enable or enhance the sharing experience.

Table 1 describes a some combinations of state selector usage, including those shown in FIGS. 17 and 18, keeping in mind that any of the functions can be assigned to any of the state selectors.

TABLE 1

| B1 | B2 | B3 | RESULT |
|---|---|---|---|
| ON | OFF | OFF | The computerized pendant is active using the default |
| | | | set of output audio instructions, but the amplifier is |
| | | | off to save power. This is FIG. 17, as shown by the |
| | | | indicator lights. |
| OFF | N/A | N/A | The computerized pendant is off, so there is no |
| | | | transformation of the input audio data, and there is |
| | | | no amplification, meaning the system functions |
| | | | the same as an ordinary set of headphones. |
| ON | ON | OFF | The computerized pendant is active, and a user- |
| | | | selected or user-defined set of output audio |
| | | | instructions, preset or custom, is being used, |
| | | | but the amplifier is off to save power. |
| ON | ON | ON | All functions are on; the computerized pendant is |
| | | | active, the user-selected or user-defined set of output |
| | | | audio instructions, preset or custom is being used, |
| | | | and the amplifier is active, either for solo or shared |
| | | | use. |

The systems can be designed to facilitate the creation and download of custom audio profiles by a user of the system. As such, in some embodiments, the memory can include a plurality of sets of instructions, at least one of the plurality of sets of instructions instructing the computer to transform the input audio data set into an independent or distinct, user-defined output audio profile. Likewise, the systems can be designed to facilitate the ease of selection of one or more default output audio profiles. As such, in some embodiments, the memory includes a plurality of sets of instructions, at least one of the plurality of sets of instructions instructs the computer to transform the input audio data set into a default output audio profile.

In some embodiments, the amplifier can serve as a preamp slider, wherein a state selector can be provided which adjusts the overall gain through the equalizer using the amplifier. As you increase the amplitude in each frequency channel, you can “clip” or saturate the signal by pushing it to the edge of its dynamic range, producing static. The preamp allows you to reduce the power equally through all frequencies, maintaining the current output audio profile while reducing any saturation produced by the profile.

It should be appreciated that, in most any embodiment, the system can be configured to receive data through a wireless technology, such as a BLUETOOTH technology, and the like. In some embodiments, a CSR 8670 BLUETOOTH radio chipset can be used. And, in some embodiments, a CSR 8645 radio chipset can be used. In some embodiments, the pendant can communicate with an audio source through a wireless connection. In some embodiments, the pendant can connect with a cellular phone, or smart phone through a wireless connection, and the system can include a microphone for two-way communications. Likewise, in some embodiments, the pendant itself can comprise a cellular phone technology for sending and receiving cellular data on it's own, such as cellular telephone data.

In some embodiments, the pendant further comprises a selection engine on a non-transitory computer readable medium for selecting a set of output audio instructions from a plurality of sets of output audio instructions. The set of output audio instructions can represent a single, structured output audio profile, or it can include a plurality of structured output audio profiles. The plurality of structured output audio profiles can be fixed upon download, or the computer in the pendant can have the functionality of starting with a particular structured output audio profile that can be altered at the headphone system by the user. In some embodiments, the set of output audio instructions can be a software download that alters, or augments, a current set of audio instructions residing in the memory of the computer of the headphones. For example, a system provided herein may contain a set of output audio instructions called “Rock”, and an update may be available, a “patch” to alter or correct the current structure of the audio profile of the “Rock” instructions at the headphone system. In order to receive a set of output audio instructions, a receiving module on a non-transitory computer readable medium can be provided in the memory of the computer for receiving a set of user-selected output audio instructions from a peripheral device. The receiving module can be operably connected to the database for storing the set of user-selected output audio instructions. In some embodiments, the receiving module can receive a data download using a wireless technology, such as a BLUETOOTH technology, and the like; and, in some embodiments, the pendant can include a port for connecting a peripheral device to the computer to receive a download such as, for example, the set of user-selected output audio instructions from the peripheral device.

As such, one of skill will appreciate having a system with a pendant that further comprises a combination of an amplifier circuit; a receiving module on a non-transitory computer readable medium for receiving a set of user-selected output audio instructions from a peripheral device, the receiving module operably connected to the database for storing the set of user-selected output audio instructions; and, a port for connecting a peripheral device to the computer to receive the set of user-selected output audio instructions from the peripheral device.

Moreover, one of skill will appreciate having a system with a pendant that further comprises a combination of a receiving module on a non-transitory computer readable medium for receiving a set of user-selected output audio instructions from a peripheral device, the receiving module operably connected to the database for storing the set of user-selected output audio instructions; a port for connecting a peripheral device to the computer to receive the set of user-selected output audio instructions from the peripheral device; and, a selection engine on a non-transitory computer readable storage medium for selecting a set of output audio instructions from a plurality of sets of output audio instructions.

Moreover, one of skill will appreciate having a system with a pendant that further comprises a combination of an amplifier circuit; a receiving module on a non-transitory computer readable storage medium for receiving a set of user-selected output audio instructions from a peripheral device, the receiving module operably connected to the database for storing the set of user-selected output audio instructions; a port for connecting a peripheral device to the computer to receive the set of user-selected output audio instructions from the peripheral device; and, a selection engine on a non-transitory computer readable storage medium for selecting a set of output audio instructions from a plurality of sets of output audio instructions.

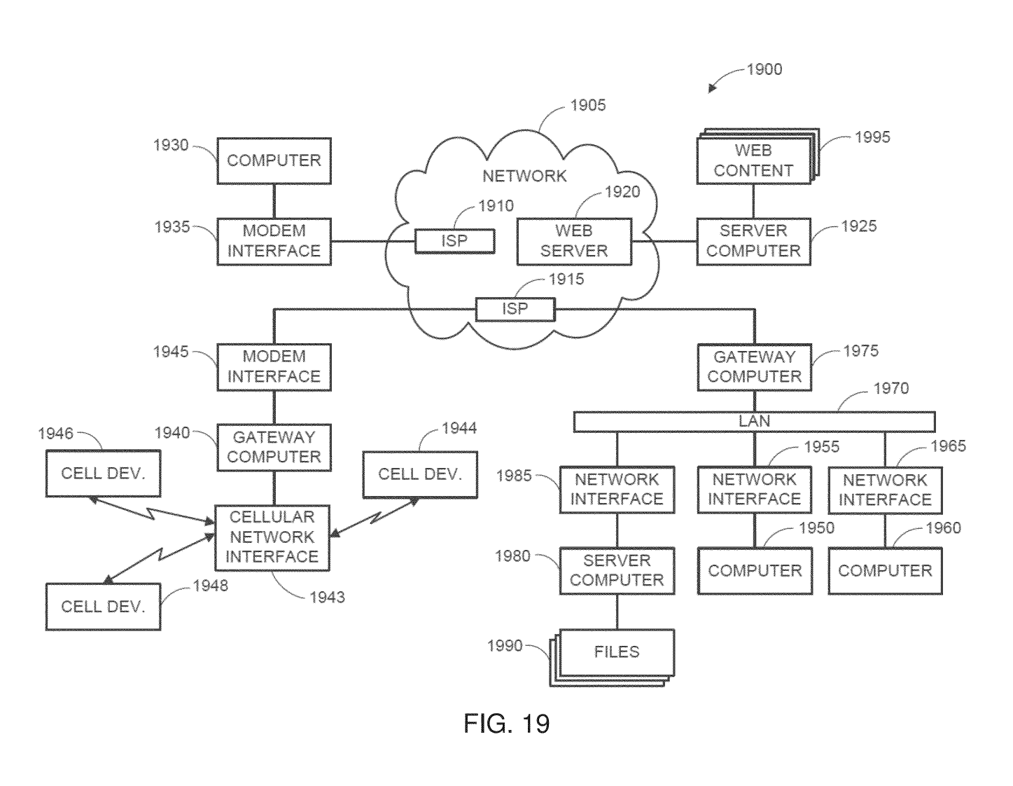

FIG. 19 shows how a network may be used for the system, according to some embodiments. FIG. 19 shows several computer systems coupled together through a network 1905, such as the internet, along with a cellular network and related cellular devices. The term “internet” as used herein refers to a network of networks which uses certain protocols, such as the TCP/IP protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 1905 is typically provided by internet service providers (ISP), such as the ISPs 1910 and 1915. Users on client systems, such as client computer systems 1930, 1950, and 1960 obtain access to the internet through the internet service providers, such as ISPs 1910 and 1915. Access to the internet allows users of the client computer systems to exchange information, receive and send e-mails, and view documents, such as documents which have been prepared in the HTML format. These documents are often provided by web servers, such as web server 1920 which is considered to be “on” the internet. Often these web servers are provided by the ISPs, such as ISP 1910, although a computer system can be set up and connected to the internet without that system also being an ISP.

The web server 1920 is typically at least one computer system which operates as a server computer system and is configured to operate with the protocols of the world wide web and is coupled to the internet. Optionally, the web server 1920 can be part of an ISP which provides access to the internet for client systems. The web server 1920 is shown coupled to the server computer system 1925 which itself is coupled to web content 1995, which can be considered a form of a media database. While two computer systems 1920 and 1925 are shown in FIG. 19, the web server system 1920 and the server computer system 1925 can be one computer system having different software components providing the web server functionality and the server functionality provided by the server computer system 1925 which will be described further below.

Cellular network interface 1943 provides an interface between a cellular network and corresponding cellular devices 1944, 1946 and 1948 on one side, and network 1905 on the other side. Thus cellular devices 1944, 1946 and 1948, which may be personal devices including cellular telephones, two-way pagers, personal digital assistants or other similar devices, may connect with network 1905 and exchange information such as email, content, or HTTP-formatted data, for example. Cellular network interface 1943 is coupled to computer 1940, which communicates with network 1905 through modem interface 1945. Computer 1940 may be a personal computer, server computer or the like, and serves as a gateway. Thus, computer 1940 may be similar to client computers 1950 and 1960 or to gateway computer 1975, for example. Software or content may then be uploaded or downloaded through the connection provided by interface 1943, computer 1940 and modem 1945.

Client computer systems 1930, 1950, and 1960 can each, with the appropriate web browsing software, view HTML pages provided by the web server 1920. The ISP 1910 provides internet connectivity to the client computer system 1930 through the modem interface 1935 which can be considered part of the client computer system 1930. The client computer system can be a personal computer system, a network computer, a web TV system, or other such computer system.

Similarly, the ISP 1915 provides internet connectivity for client systems 1950 and 1960, although as shown in FIG. 19, the connections are not the same as for more directly connected computer systems. Client computer systems 1950 and 1960 are part of a LAN coupled through a gateway computer 1975. While FIG. 19 shows the interfaces 1935 and 1945 as generically as a “modem,” each of these interfaces can be an analog modem, isdn modem, cable modem, satellite transmission interface (e.g. “direct PC”), or other interfaces for coupling a computer system to other computer systems.

Client computer systems 1950 and 1960 are coupled to a LAN 1970 through network interfaces 1955 and 1965, which can be ethernet network or other network interfaces. The LAN 1970 is also coupled to a gateway computer system 1975 which can provide firewall and other internet related services for the local area network. This gateway computer system 1975 is coupled to the ISP 1915 to provide internet connectivity to the client computer systems 1950 and 1960. The gateway computer system 1975 can be a conventional server computer system. Also, the web server system 1920 can be a conventional server computer system.

Alternatively, a server computer system 1980 can be directly coupled to the LAN 1970 through a network interface 1985 to provide files 1990 and other services to the clients 1950, 1960, without the need to connect to the internet through the gateway system 1975.

Through the use of such a network, for example, the system can also provide an element of social networking, whereby users can contact other users having similar subject-profiles. In some embodiments, the system can include a messaging module operable to deliver notifications via email, SMS, and other mediums. In some embodiments, the system is accessible through a portable, single unit device and, in some embodiments, the input device, the graphical user interface, or both, is provided through a portable, single unit device. In some embodiments, the portable, single unit device is a hand-held device. In some embodiments, the systems and methods can operate from the server to a user, from the user to a server, from a user to a user, from a user to a plurality of users, in an MMO environment, from a user to a server to a user, from a server to a user (or plurality of users)

The teachings above suggest methods of making and using a computerized headphone system. As such, a method of constructing a set of computerized, portable headphones is provided. In some embodiments, the method comprises constructing a set of portable headphones having a left ear speaker, a right ear speaker. The constructing can include assembling a pendant having a computer with a processor and a memory operably connected to the processor for a transforming of an input audio data set into a structured output audio profile having a preselected distribution of relative audio amplitudes over a corresponding set of audio frequencies. The method can also include configuring the memory to include a database, a transformation module, and an output module; and, attaching the pendant to hang from the set of portable headphones. The method can also include creating a set of output audio instructions for downloading to the computer, the output audio instructions configured for the transforming of the input audio data set into the structured output audio profile. The set of computerized, portable headphones can be configured function to transform the input audio data set into the structured output audio profile having the preselected distribution of relative audio amplitudes over the corresponding set of audio frequencies for receiving through the left speaker and the right speaker.

A method of transforming an input audio data set into a structured output audio profile having a preselected distribution of relative audio amplitudes over a corresponding set of audio frequencies for receiving through a set of headphones is also provided. In some embodiments, the method comprises obtaining a headphone system taught herein. The method can include transforming the input audio data set into the structured output audio profile; and, receiving the structured output audio profile through the set of headphones.

In some embodiments, the method includes obtaining a system having an amplifier circuit and engaging the amplifier circuit to amplify frequencies of the input audio data set in the transforming of the input audio data set into the structured output audio profile.

In some embodiments, the method includes obtaining a system having a selection engine on a non-transitory computer readable storage medium for selecting a set of output audio instructions from a plurality of sets of output audio instructions. And, in some embodiments, the method further comprises selecting a set of output audio instructions from a plurality of sets of output audio instructions using the selection engine.

In some embodiments, the method includes obtaining a system having a receiving module on a non-transitory computer readable medium for receiving a set of user-selected output audio instructions from a peripheral device; and, a port for connecting a peripheral device to the computer. And, in some embodiments, the method further comprises receiving a set of user-selected output audio instructions from the peripheral device.

In some embodiments, the method includes obtaining a system having an amplifier circuit; a receiving module on a non-transitory computer readable medium for receiving a set of user-selected output audio instructions from a peripheral device; and, a port for connecting a peripheral device to the computer to receive the set of user-selected output audio instructions from the peripheral device. And, in some embodiments, the method further comprises engaging the amplifier circuit; and, receiving the set of user-selected output audio instructions from the peripheral device.

In some embodiments, the method includes obtaining a system having a receiving module on a non-transitory computer readable medium for receiving a set of user-selected output audio instructions from a peripheral device; a port for connecting a peripheral device to the computer to receive the set of user-selected output audio instructions from the peripheral device; and, a selection engine on a non-transitory computer readable storage medium for selecting a set of output audio instructions from a plurality of sets of output audio instructions. And, in some embodiments, the method further comprises receiving the set of user-selected output audio instructions from the peripheral device; and, selecting a set of output audio instructions from a plurality of sets of output audio instructions using the selection engine.

In some embodiments, the method includes obtaining a system having an amplifier circuit; a receiving module on a non-transitory computer readable storage medium for receiving a set of user-selected output audio instructions from a peripheral device; a port for connecting a peripheral device to the computer to receive the set of user-selected output audio instructions from the peripheral device; and, a selection engine on a non-transitory computer readable storage medium for selecting a set of output audio instructions from a plurality of sets of output audio instructions. And, in some embodiments, the method further comprises engaging the amplifier circuit; receiving the set of user-selected output audio instructions from the peripheral device; and, selecting a set of output audio instructions from a plurality of sets of output audio instructions using the selection engine.

In some embodiments, the method includes obtaining a system having a control switch operably connected between the set of headphones and the computerized pendant in the left cable or the right cable, the control switch having a state selector for an engaging, or a disengaging, of the transforming of the input audio data set into the structured output audio profile. And, in some embodiments, the method further comprises the engaging, or the disengaging, of the transforming of the input audio data set into the structured output audio profile.

In some embodiments, the method includes obtaining a system having a control switch operably connected between the set of headphones and the computerized pendant in the left cable or the right cable, the control switch having a state selector for an engaging, or a disengaging, of the amplifier circuit. And, in some embodiments, the method further comprises the engaging, or the disengaging, of the amplifier circuit to amplify frequencies of the input audio data set in the transforming of the input audio data set into the structured output audio profile.

In some embodiments, the method includes obtaining a system having a control switch operably connected between the set of headphones and the computerized pendant in the left cable or the right cable, the control switch having a state selector for a selecting of a set of output audio instructions from a plurality of sets of output audio instructions. And, in some embodiments, the method further comprises the selecting of the set of output audio instructions from the plurality of sets of output audio instructions.

The following examples are illustrative of the uses of the present teachings. It should be appreciated that the examples are for purposes of illustration and are not to be construed as otherwise limiting to the teachings.

### Example 1

### Downloadable Static Equalizer Setting

The range of sound frequencies that can be heard by a human generally ranges from about 20 Hz to about 20,000 Hz and, since this range represents extreme low frequency to extreme high frequency, the range that is usually used in sound production generally ranges from about 50 Hz to about 15,000 Hz. As such, the frequency ranges that can be transformed herein may range, for example, from about 20 Hz to about 20,000 Hz, from about 30 Hz to about 18,000 Hz, from about 32 Hz to about 16,000 Hz, from about 35 Hz to about 16,000 Hz, from about 40 Hz to about 16,000 Hz, from about 50 Hz to about 15,000 Hz, from about 55 Hz to about 15,000 Hz, from about 60 Hz to about 14,000 Hz, or any range therein in increments of 5 Hz.

The gain, or volume, is adjusted per frequency interval and the can be measured in terms of decibels, which is logarithmic measurement unit that describes a sound's relative loudness, though it can also be used to describe the relative difference between two power levels. In sound, decibels generally measure a scale from 0 (the threshold of hearing) to 120-140 dB (the threshold of pain), where a 3 dB difference generally equates to a doubling of power. A 10 dB difference, for example can be considered the amount needed to double the subjective volume. A 1 dB difference over a broad frequency range, on the other hand, will generally be noticeable to most people, whereas a 0.2 dB difference can affect the subjective impression of a sound. Examples of decibel readings include, for example, about 150 dB for a firecracker; about 140-150 dB for a jet aircraft taking off; about 135-140 dB for a rock concert or gunshots; about 120 dB for an ambulance siren or nightclub; about 85-90 dB for a jackhammer at 15 meters or a subway; about 70-75 dB for an average city street or restaurant; about 60-80 dB for a quiet conversation or telephone dial tone; about 45 dB for an office environment; about 30 dB for a whisper at 3 meters, and about 20 dB for a “silent” TV studio. The threshold of hearing is standardized at 0 dB. More relevant to the technology at-hand . . . listening to music with headphones might be as high as about 105 dB to about 120 dB, if the volume is cranked-up to the maximum setting; and, earbuds, such as those found with popular music-listening devices like MP3 and CD players, can add 6-9 dB to the volume. A user of a set of headphones or earphones, for example, might listen at a decibel level ranging from about 77 dB to about 85 dB or more.

The decibel level can be affected by the power level used by a set of headphones. Sensitivity is how effectively an earphone converts an electrical signal into an acoustical signal. Sensitivity indicates how loud the earphones will be for a given level from the source. This measurement is given in decibels of Sound Pressure Level per milliwatt, or dB SPL/mW. In some cases, it might be shown as dB/mW and is based on a 1 mW input signal. One mW is one thousandths of a Watt, or 0.001 Watts. The sensitivity of earphones is usually in the range of about 80 to about 125 dB SPL/mW.

For example, a set of earphones (“the earphones”) having a sensitivity of 122 dB SPL/mW generate 122 dB SPL with 1 mW of power. A typical earphone output could provide this level. Note that dB SPL do not sum in a linear manner, such that 2 mW, relatively speaking, will not generate 244 dB SPL. Doubling or halving the input power increases or decreases the SPL by 3 dB. For example, a 0.5 mW input into the earphones would be expected to generate 119 dB SPL. Moreover, a sensitivity rating for earphones do not mean much until matched with the output capabilities of an audio system or audio source. If an audio source has low output level, using a low sensitivity earphone will result in low SPL. Increasing the amplifier level in this configuration, unfortunately, will lead to distorted audio due to amplifier clipping. On the other hand, a high sensitivity earphone coupled with a high power amplifier will force a low volume setting, which can result in more noise. A classic problem is connecting a pair of earphones to an airplane sound system, where setting the volume at the first position, right above zero, gives enough level but is noisy, and increasing the volume makes it too loud to use. A simple, passive earphone attenuator solves this problem by reducing the level being delivered to the earphones, allowing you to raise the volume of the earphone amplifier to a setting that produces less noise. The following table shows the SPL output level for three earphones at different source levels.

TABLE 2

| | EARPHONE 1 | EARPHONE 2 | EARPHONE 3 |
|---|---|---|---|
| INPUT POWER | 113.5 dB | 105.0 dB | 122.0 dB |
| (mW) | SPL/mW | SPL/mW | SPL/mW |
| 0.1 | 103.5 | 95.0 | 112.0 |
| 0.2 | 106.5 | 98.0 | 115.0 |
| 0.5 | 110.5 | 102.0 | 119.0 |
| 0.8 | 112.5 | 104.0 | 121.0 |
| 1.0 | 113.5 | 105.0 | 122.0 |
| 1.2 | 114.3 | 105.8 | 122.8 |
| 1.5 | 115.3 | 106.8 | 123.8 |

Given the sound pressure levels for the three sets of earphones, the following table can be used to show how the transformation module in a system as taught herein can execute a set of output audio instructions to obtain a desired output audio profile using the transformation module in the computerized pendant set-forth herein. Table 3 shows, for example, how a flat input audio profile can be transformed into a parabolic profile through digital signal processing (DSP), which may be considered desirable by a user of such a system when listening to rock music, for example.

TABLE 3

| | INPUT AUDIO | | | OUTPUT |
|---|---|---|---|---|
| | AMPLITUDES | | | AUDIO |
| | (dB); 0-120 dB | | OUTPUT | AMPLITUDES |
| INPUT AUDIO | range | | AUDIO | (dB); 0-120 |
| FREQUENCY | (flat linear | | FREQUENCY | (parabolic |
| (Hz) | profile) | TRANSFORMATION | (Hz) | profile) |
| 60 | 105 | −0 | 60 | 105 |
| 230 | 105 | −10 | 230 | 95 |
| 910 | 105 | −20 | 910 | 85 |
| 3K | 105 | −10 | 3K | 95 |
| 14K | 105 | −0 | 14K | 105 |

It should be appreciated that the transformation is a mathematical transformation of a set of input amplitude profiles into a set of output amplitude profiles, and the mathematical transformation can produce any desired output audio amplitude profile. The transformation module can measure the input audio amplitudes across the frequency range, for example, to establish an input value for each frequency point selected. It should be appreciated that, in some embodiments, a frequency point used for gain adjustment is merely a midpoint of a frequency range that is transformed. For example, the input audio of 60 Hz can be a midpoint that represents a peak value in the range of 20 Hz to 145 Hz; the input audio frequency of 230 Hz can be a midpoint that represents a peak value in the range of 145 Hz to 570 Hz; the input audio frequency of 910 Hz can be a midpoint that represents a peak value in the range of 570 Hz to 1955 Hz; the input audio frequency of 3K Hz can be a midpoint that represents a peak value in the range of 1955 Hz to 8.5K Hz; and, the input audio frequency of 14K Hz can be a midpoint that represents a peak value in the range of 8.5K Hz to 20K Hz. One of skill will appreciate how each frequency point for gain adjustment across the frequency range heard can be selected and used to represent frequency ranges for establishing a select, output audio profile. Each of the frequency ranges can be referred to as a “band” in some embodiments.

The set of output audio instructions provide digital signal processing that can instruct the input audio data set into the structured output audio profile across any number of bands. The set of output audio instructions can instruct the input audio data set into the structured output audio profile across 3 bands, across 4 bands, across 5 bands, across 6 bands, across 7 bands, across 8 bands, across 9 bands, across 10 bands, across 11 bands, across 12 bands, across 13 bands, across 14 bands, across 15 bands, across 20 bands, across 25 bands, across 30 bands, or any number of bands therein in increments of 1 band.

As can be seen from the above, the set of output audio instructions can be a static set of instructions that transform an input audio data set into a structured output audio profile having a preselected distribution of relative audio amplitudes over a corresponding set of audio frequencies. As such, the input audio amplitude profile is transformed into the desired output audio amplitude profile. One of skill will appreciate that the implementation of an amplifier circuit, as taught herein, can be useful to produce a desired volume, as well as raise the clipping point where the sound begins to distort for the user.

### Example 2

### Downloadable Set of Static Equalizer Settings

This example describes how the system can be configured to offer a user a plurality of equalizer settings rather than just a single equalizer setting.

The database of the computerized pendant can store a plurality of static equalizer settings. The plurality of static equalizer settings would be a set of static equalizer settings that would offer the user a plurality of sets of output audio profiles in the computerized pendant providing expanded digital signal processing options directly in the computerized pendant. As such, the user can activate a state selector, for example, by toggling-through the set of static equalizer settings, for example, to match a desired profile to a particular genre of music as described herein.

### Example 3

### Downloadable Equalizer Settings with Real-Time Control

One of skill will appreciate that the plurality of static equalizer settings represent fixed transformations across the audible frequency range. As such, a real-time control can also be designed into the computerized pendant for an even further enhanced digital signal processing by downloading a series of static equalizer settings that can be traversed real-time by one or more state selectors. In some embodiments, one state selector can be used, and the real-time control would merely toggle through one series of static equalizer settings. In some embodiments, a plurality of state selectors can be used, each of which can represent a frequency point, or band, as defined above in Example 1 for real-time digital signal processing of individual bands, each band having its own series of static equalizer settings that can be traversed real-time. The number of permutations of equalizer settings increases tremendously in the combination of series offered through each state selector.

A real-time environment can provide a response to a command to execute the equalizer instructions within set time constraints, or “deadlines”. Real-time responses, for example, can be provided on the order of milliseconds, and sometimes microseconds, ranging from 0.001 milliseconds to 999 milliseconds, from 0.01 milliseconds to 900 milliseconds, from 0.02 milliseconds to 800 milliseconds, from 0.03 milliseconds to 700 milliseconds, from 0.04 milliseconds to 600 milliseconds, from 0.05 milliseconds to 500 milliseconds, from 0.06 milliseconds to 400 milliseconds, from 0.07 milliseconds to 300 milliseconds, from 0.08 milliseconds to 200 milliseconds, from 0.09 milliseconds to 100 milliseconds, from 0.10 milliseconds to 50 milliseconds, from 1.0 milliseconds to 10 milliseconds, or any range therein in increments of 0.001 millisecond. In some embodiments, the system response occurs without perceivable delay. It should be appreciated that the network can also be configured to provide output audio instructions and, in some embodiments, provide the instructions in real-time.

### Example 4

### Downloadable Equalizer Settings to Tailor Output Audio Profiles to Address Right-to-Left Hearing Level Deviations Between Users

A typical human might be expected to have some right-to-left hearing level deviation and, to many people, this is much more of an issue when wearing earphones or headphones. The reason behind this is that the isolation of the acoustic signal going in each of the users ears is practically 100%. Simply stated, when you have an earphone set in your ears, you cannot perceive the sound from the left channel in your right ear and vice-versa. However, when listening to a typical free-field sound, for instance, a typical home stereo system or table radio, both of your ears are receiving the same acoustic signal, albeit at slightly different levels. As such, a right-to-left hearing level deviation is much more difficult to notice and, for those of us with subtle differences in the right and left ear auditory sensitivity and range, the difference is largely unnoticed. When you change the environment by isolating the right and left ears as in the case of an earphone, the users ears are receiving discrete signals, both at specific levels. For many people, the sensation of imbalance from the right to left ear is noticeable and aggravating, particularly when they first begin using their earphones or headphones.

The systems provided herein allow the user to adjust the relative right and left decibel level of the earphones in the digital domain. The user connects their computerized pendant to their web-enabled peripheral device and is able to independently set the right and left decibel levels, while wearing the device. This process can be done in real-time via a test tone that can be supplied through a download to the computerized pendant through either an internet connection with the peripheral web-enabled device. And, in some embodiments, the download can go directly to the pendant from the internet connection. The relative level can be displayed, for example, in graphic and/or numeric formats. The user can identify and save the personalized balance settings at the computerized pendant. The memory registers are coded and the device will remain in that state until reprogrammed. The setting can be easily reset to zero at the right and/or left side with a simple push of a button.

### Example 5

### Configuring a System for Sharing an Output Audio with a Second User at the Computerized Pendant of the Headphone Systems Taught Herein

This example describes how the computerized headphone systems and methods provided herein offer a way to share the audio with a second listener. This can be advantageous, for example, when listening to music or watching a video having audio.

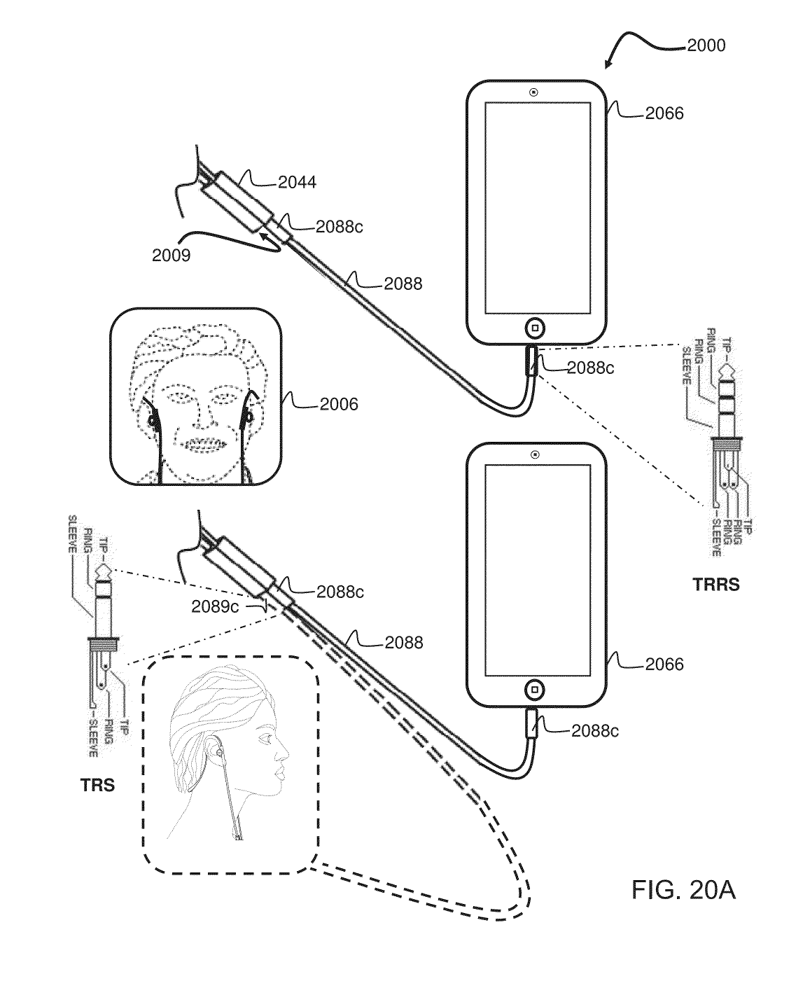

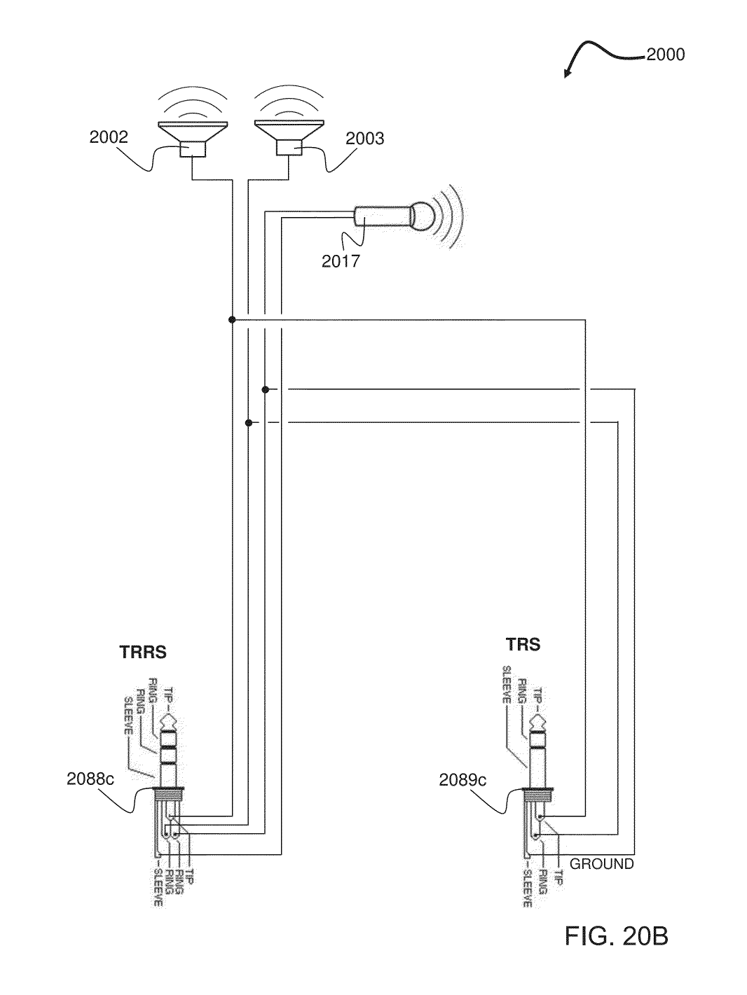

FIGS. 20A and 20B illustrate a system configuration for sharing an output audio with a second user at the computerized pendant of the headphone system, according to some embodiments. The user 2006 of the computerized headphone system 2000 connects the audio cable 2088 into an audio source 2066 using a tip-ring-ring-sleeve (TRRS) connector 2088c and selects the output audio profile transformation for listening through the left ear speaker 2002 and right ear speaker 2003. The second listener can share by connecting a tip-ring-sleeve (TRS) connector 2089c into the park/share port 2009 of the computerized pendant 2044. The TRS connector 2089c at the park/share port 2009 prevents the second listener from interfacing with the user's microphone 2017 line, perhaps creating an overload or failure of the microphone bias driver. In some embodiments, the problem is overcome by dedicating an input and output audio sharing configuration, using the TRRS format for the input and the TRS format for the output, eliminating the parallel connection of the microphone bias drivers, preventing the secondary listening device from being able to create a command or other conflict. One of skill will appreciate that any conceivable connector configuration can be used to achieve the functions taught herein. For example, in some embodiments, regardless of the connector type used to achieve the function, the primary user's connection to the peripheral device or audio source is a “master” connection and, likewise, the secondary user's connection can be merely a “slave” connection that only receives a shared audio through the computerized pendant.

### Example 6

### Configuring Headphones with Struts to Indicate Left Ear and Right Ear Positions

This example describes the strut/capsule configuration that, particularly when combined with the neckband, address the problem of placing the right ear capsule in the left ear and left ear capsule in the right ear, and, as a natural extension, the problem of not creating a proper coupling between the capsule and the ear.

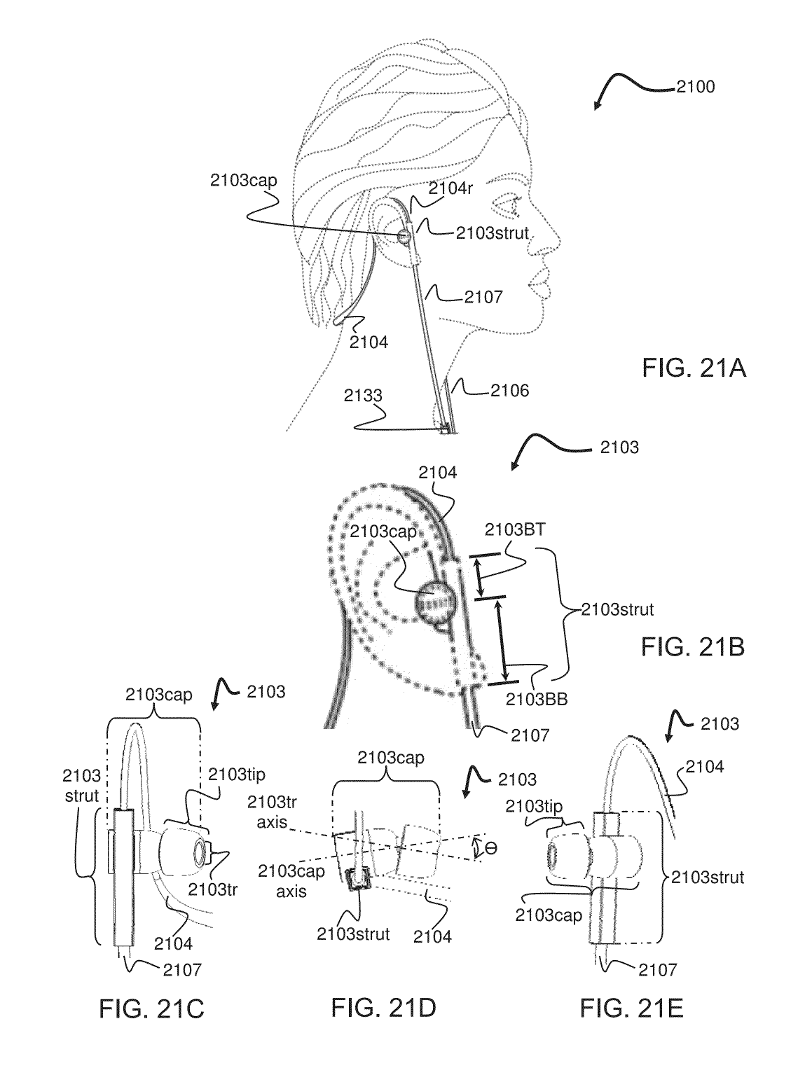

FIGS. 21A-21E illustrate a strut/capsule configuration that indicates left ear and right ear positions, according to some embodiments. As shown in FIG. 21A, system 2100 is a canalphone/headphone system positioned on a user with the capsule 2103cap positioned at the ear canal with the neckstrap 2104 having a left-end (not shown; but is a mirror image of the right end 2104r) operably attached to the top-end of the left cable brace (left strut; not shown but is a mirror image of the right strut 2103strut and a right-end 2104r operably attached to the top-end of the right cable brace (right strut) 2103strut. The system 2100 also has a left cable 2106 operably connecting the output module of the computer (not shown) to the left ear speaker (left capsule; not shown but is a mirror image of the right capsule) through the bottom of the left cable brace (left strut; not shown but is a mirror image of the right strut 2103strut). Likewise, the system 2100 also has a right cable 2107 operably connecting the output module of the computer (not shown) to the right ear speaker (right capsule) 2103cap through the bottom of the right cable brace (right strut) 2103strut.

As shown in FIG. 21B, the design can include a strut/capsule configuration that indicates left ear and right ear positions. For example, the left cable brace (left strut; not shown but is a mirror image of the right strut 2103strut) is a structural beam having a top portion with a length that is shorter than the bottom portion and the right cable brace (right strut) 2103strut is a structural beam having a top portion 2103BT with a length that is shorter than the bottom portion 2103BB.

FIGS. 21C-21E show the strut/capsule configuration that is used to selectively position the right transfer vent 2103tr of the capsule 2103cap into the right ear canal. One of skill will appreciate that the strut/capsule configuration for the left transfer vent (not shown) and left ear canal are the mirror image of the strut/capsule configuration for the right transfer vent 2103tr and right ear canal. As shown in FIGS. 21A-21E, the left ear speaker (left capsule; not shown but is the mirror image of the right capsule 2103cap) is operably attached posterior to the left cable brace (left strut; not shown but is the mirror image of the right strut 2103strut) and the right ear speaker (right capsule) 2103cap is operably attached posterior to the right cable brace (right strut) 2103strut. The left cable brace (left strut; not shown but is a mirror image of the right strut 2013strut) is a structural beam and the right cable brace is a structural beam. The left cable brace (left strut; not shown but is a mirror image of the right strut 2103strut) can be a cuboidal beam and the right cable brace (right strut) 2103strut is a cuboidal beam.

The right strut/capsule configuration 2103strut,2103cap provides a unique functionality in the art through the creating of “right-sidedness” and “left-sidedness” to the strut/capsule configurations. The strut/capsule configurations create a misalignment between the strut and the pinna of the ear, creating an uncomfortable relationship between the strut and pinna if the capsule is not inserted into the correct respective ear. The right strut 2103strut, for example, is configured for positioning in front of the right ear, anterior to the right pinna, without such interference from the right pinna and, likewise, directs the cable 2107 in front of the right pinna and over the right pinna without interference from the right pinna. If the user attempts to install the right capsule 2103cap into the left ear, the right strut 2103strut will not allow the right transfer vent 2103tr to establish a comfortable placement into the left ear canal due to (i) the strut/capsule combination, and (ii) the angle θ, of the central axis of the right transfer vent 2103trₐₓᵢₛ, which is measure from the central axis of the body of the right capsule 2103capₐₓᵢₛ. As such, the left strut/capsule configuration (not shown) also will not allow the left transfer vent (not shown) into the right ear canal. The right eartip 2103tip might be able to be placed in front of the right ear, but the connection will not be comfortable or fully functional. In any event, a reasonable person will, at the very least, find it very uncomfortable to try and insert the left capsule (not shown) in the right ear, or the right capsule 2103cap into the left ear, due to the pinna of the ear pushing against each improperly placed strut and the angle θ of the central axis of the transfer vent.

### Example 7

### Protection of the User from Electromagnetic Energy

This example describes a configuration that can be used to help block the user from electromagnetic energy, or the electromagnetic field (EMF), that is generated by a headphone system provided herein.

Studies have suggested that the health effects of EMFs are cumulative, and anything electrical emits EMFs, such as headphones. As such, the strut/capsule configuration 2103 shown in FIG. 21 can be configured with a material that is effective at blocking at least a substantial amount of the EMFs produced at the strut/capsule location. In some embodiments, a strut 2103 can at least partially contain a cork material, for example, to block EMFs. Any species of cork containing suberin can be used, in some embodiments. For example, the species of Quercus suber (the Cork Oak) can be used. Any EMF shielding materials can be used, such, for example, EMF shielding coatings or paints, EMF shielding plastics, EMF shielding fabrics, or EMF shielding foils. See, for example, http://www.lessemf.com/ (downloaded Jun. 23, 2014), which is hereby incorporated herein by reference in it's entirety for EMF shielding materials, in particular MAGNETSHIELD, JOINT-SHIELD, and MAGSTOP PLATE.

### Example 8

### An Amplified, Dual-Channel Canalphone Set

This example describes an amplied, dual-channel canalphone set with an APPLE function control switch. Amplification is performed in a modular, computerized pendant that hangs from the signal wiring. The right and left channel transducer assemblies have a neckband extending out of the top of the assemblies, the neckband functioning as a means for holding the product around the user's neck or as an over-the-ear support.

The Headphones; Canalphones and Eartips

The canalphones (or transducer capsules) may produced in at least the 3 following ways:
1. a single balanced armature per channel (Knowles RAB or similar);
2. a single dynamic transducer per channel (9 mm, 10 mm both acceptable); or,
3. a hybrid transducer set consisting of a single balanced armature for the mid and high frequency bands and a single 8 mm or 9 mm dynamic driver for low frequency (one set per channel), a configuration that can (i) provide good bass frequencies without breaking-up the midrange frequencies, splitting the canalphone into woofer and tweeter components, and (ii) a better response to digital signal processing (DSP).

The eartips can be molded silicone and/or memory foam, and each transducer capsule is affixed to a strut, which can be made from any desirable material known to one of skill to serve as a brace or beam or otherwise a support structure such as, for example, plastic, metal or metal alloy, such as titanium, aluminum, or aluminum alloy. The struts relieve the strain placed upon the cables that enter the transducer capsules from the computerized pendant for the left and right channels. In some embodiments, the headphone system can be a 2-channel audio solution and, in some embodiments, a 4-channel audio solution. For example, the 4-channel solution may work particularly well with the hybrid transducer configuration discussed above.

Table 4 describes a headphone configuration that may be used in a system provided herein.

TABLE 4
HEADPHONES

| transducer - option 1 | single balanced armature, e.g., KNOWLES RAB-32257-000 or variant | |
|---|---|---|
| transducer - option 2 | single dynamic transducer with, for example, a 9 mm or 10 mm | |
| | dynamic driver | |
| transducer - option 3 | hybrid transducer set (1BA + 1 dynamic) with a single balanced | |
| | armature for the mid and high frequency bands and a single 8 mm or | |
| | 9 mm dynamic driver for low frequency (one set per channel) | |
| impedance | Impedance adjusted for above options, e.g., a 32 ohm system 32 Ohm | |
| | @ 500 Hz | |
| DCR (DC resistance) | adjusted for transducer | e.g., DC resistance (DCR) for the |
| | configuration | balanced armature should be in the |
| | | 22-24 range. |
| frequency response | 18 Hz-20 KHz + 2 dB-3 dB | match to average transducer |
| | | response using, e.g., IEC 60318- |
| | | 4(711) cavity; 0.115 Vrms sine |
| | | swept stimulus. DC bias = 0.0 |
| sensitivity | >105 dB | Max SPL Set via DSP/limiting in |
| | | the pendant |
| distortion | <2.25% | Transducer distortion before DSP/ |
| | | Correction |
| ambient noise | >24 dB | Passive attenuation only for this |
| attenuation (passive | | model |
| mode) | | |

| | |
|---|---|
| earbud assembly - | Transducer capsules are UV coated; Multi-part assembly consisting of |
| general | UV coated plastic transducer capsules mated to aluminum struts. |
| | Right and left channels are unique. Acoustic vent OD is approximately |
| | 5.3 mm |
| eartips | silicone; large, medium and small/memory foam |

The Cables, Neckband and/or Carry Case.

All cables can be jacketed with thermoplastic elastomer (TPE), with a polycotton or similar interleave braided covering. The covering can be soft/comfortable to the touch without significant stiffness or lack of drape-ability to the cable sets as they conform to the body of a user. The main audio input cable can be configured with gold plated 4 pole TRS jacks at both ends, and the jack assembly cover (casing) might be made of polycarbonate or similar with a UV finish. A charging/data cable can be provided as a standard USB or micro-USB, and the cable can be TPE with the same interleave woven polycotton jacket as the main audio cable and the pendant to capsule cables. Terminal casings can be configured as polycarbonate with a UV finishing. The neckband can be a TPE core covered with the same polycotton braid as the other cables. A carry case can be part of a kit, supplied with the set as a polymeric, cloth, or hybrid polymer/cloth bag with drawstring closure. Table 5 describes cables or neckband configurations that may be used in a system provided herein.

TABLE 5
CABLES AND NECKBAND

| | |
|---|---|
| USB to | USB power and data. TPE jacket with interleave braided polycotton cover. RoHS |
| micro | compliant terminations. Cosmetic terminal cover material is polycarbonate or similar |
| USB | RoHS and CARB/EPA compliant material - seamless UV coated finish. |
| Audio | 4 Pole arrangement (audio + mic) must be MFi compatible. TPE jacket with |
| input | interleave braided polycotton cover. Gold electroplated RoHS compliant 4 pole |
| cables | TRS connector on each end. Cosmetic terminal cover material is polycarbonate or |
| | similar RoHS and CARB/EPA compliant material-seamless UV coated finish. |
| cables | TPE with Interleave braided polycotton cover. Mfi control + Mic on RIGHT channel |
| | cable. Finished cable DIA = 2.0 mm +− 0.25 mm |

cable section length for right earbud assembly to top of Mfi switch: 105 mm +− 2 mm
cable section length for bottom of Mfi switch to pendant: 105 mm +− 2 mm
cable section length for left earbud to pendant: 245 mm +− 2 mm
cable section length for neckband: 400 mm +− 2 mm
cable section length for audio input cable: 850 mm +− 5 mm
cable section length for USB cable: 850 mm +− 5 mm

| | |
|---|---|
| neckband | TPE or similar flexible core with interleave braided polycotton cover. Finished |
| | neckband DIA = 2.5 mm +− .25 mm |

The Pendant and Control Switch

Functionally, the product is comprised of a set of channel-specific right and left canalphone capsules, discrete right and left channel signal wiring with an “MR” function switch assembly (also referred to as a “control switch” herein) on the right channel wiring. The main audio connection in the computerized pendant can be made using a standard tip-ring-sleeve socket (TRS or TRRS type). An audio-sharing socket is also provided to allow the user to share the audio with a second user. The energy source in the computerized pendant can be charged through universal serial bus connector (USB or micro-USB), which can be located between the main audio connection socket and the audio-sharing socket. This universal serial bus connector is also the port used as a data link for firmware and digital signal processing (DSP) script downloading and updating. A power indication light is provided on the pendant to show a full charge and/or low charge. Table 6 describes cables or neckband configurations that may be used in a system provided herein.

TABLE 6
CONTROL SWITCH AND PENDANT

| | |
|---|---|
| Mfi switchpack | MFI switch pack includes all standard Mfi functions as |
| (control switch) | well as a microphone. |
| pendant | The pendant has all inputs and outputs as well as the |
| | basic functionality switches and indicators as |
| | determined by the functional specification. |

The pendant houses the computer of the system. The pendant can be made from any suitable material known to one of skill such as, for example, plastic, metal or metal alloy, such as titanium, aluminum, or aluminum alloy.

The pendant can be configured with a stereo amplifier, digital signal processor (DSP) and a charge circuit control as well as an energy source (e.g., a battery), the main audio-in socket, as well as the audio sharing output socket.

The pendant can be configured with a TI chip solution that can drive a 16 ohm load. An integrated DSP can be used in some embodiments. The target power is 20-30 mW with 20 mW half power or better. A jack insert detect may be on-chip in some embodiments, or as an additional circuit in some embodiments. A fixed gain solution can also be used in some embodiments. When the pendant is in full shutdown, either (i) by being switched off or (ii) from the battery being fully discharged, audio from the phone or other device connected to the pendant must be allowed to pass through to the transducers. Of course, this can be without the benefit of amplification or DSP.

The digital signal processing (DSP) can include all DSP functions known to one of skill to be useful in the systems taught here. However, the DSP will include sound quality enhancements in many embodiments. For example, the DSP will typically have the main function of frequency/amplitude (EQ) adjustment, and some embodiments can also have enveloping or similar effects. DSP scripts can be updateable via USB input into the computerized pendant. Data exchange can be accomplished, for example, through a PC-app based updating. In some embodiments, the DSP can include soft start, soft mute return and, if available, LEQ-compensation functionality can be offered to protect against hearing damage to the user from what is called “equivalent continuous noise levels”. For example, a filter can be used and/or the DSP can function to set a max output level.

The audio connections can be a main 4 pole TRS socket on the right or left bottom side of the pendant. On the remaining bottom side of the pendant, there shall be an additional 4 pole TRS socket which allows the user to share their music with another user through the additional, sharing 4-pole TRS socket. The key difference between the main 4-pole TRS socket and the sharing 4-pole socket is that the Mfi control only functions through the main 4-pole TRS socket.

In some embodiments, the system can have an auto-shutdown feature when the main audio cable is plugged into both the main input and the sharing output (i.e., “parking” in the additional 4-pole socket as a park/share socket). This can be considered a battery conservation function of the device. In these embodiments, the circuit in the computerized pendant can again allow audio to pass-through without the benefit of amplification or DSP of the computerized pendant in the “on” configuration. Likewise, in some embodiments, the system can be configured with an auto-on function, in that the system will “power on, autodetect” with TRS jack insertion into the main 4-pole TRS socket. Moreover, in some embodiments, the system can be configured with “auto standby” when no signal is received for a set time-threshold such as, for example, for 5 minutes. This can also be considered a battery conservation function of the device.

And, of course, in some embodiments, the on/off functionality can be achieved using a tactile switch on the system, either on the control switch, the pendant, or both the control switch and the pendant. In some embodiments, the switch is a sealed tactile switch

The Energy Source

The energy source can be replaceable, rechargeable, or both replaceable and rechargeable. And, a balance will be chosen between pendant size, weight, and battery life based on reasonable performance levels, such as a performance level of approximately 75% for example. In some embodiments, the battery life can range from about 6 hours to about 8 hours, from about 8 hours to about 10 hours, from about 10 hours to about 12 hours, from about 14 hours to about 24 hours, and any amount or range therein in increments of 1 hours.

In some embodiments, the battery may be a LiFePo4 or similar battery, obtainable from BatterySpace.com/ AA Portable Power Corp., 825 South 19th street, Richmond, Calif. 94804. For example, a suitable battery might include a 3.7V LiFePo4 cell having around 300mAh. One of skill will appreciate that the battery can have a lifecycle, for example, of a minimum of 500+ discharge cycles with a target of 750 discharge cycles. One of skill will also appreciate that the “one discharge cycle” can be measured from fully charged to 80% depth-of-discharge (DoD). In some embodiments, the battery is not user serviceable, but may be replaceable through a factory service center.

In some embodiments, the system can include a status indicator either on the control switch, the pendant, or both the control switch and the pendant. In some embodiments, the status indicated can be centered on the top of the pendant. For example, the pendant can contain an LED set enabling the following color displays via a lens or “light pipe”. In some embodiments, the LED status indicator can be a light ring around the main power switch. The LED indicator can be used to keep the user informed of the state of the battery charge. In some embodiments, the LED will show current level, for example, a blue light can mean the system is on and the battery is in a normal charged condition. However, a blinking blue light can mean the battery is charging. In some embodiments, the light can alternate from blue to red indicating that the battery is low. And, the light can continuously blink or maintain a red emission to show that the battery is critical.

One of skill will also appreciate that the system must withstand physical stresses of use. Table 7 describes testing conditions that may be used to test a system provided herein.

TABLE 7
TESTING

| | |
|---|---|
| validation testing - Cable Bend | 10 degree radius fixture with 200 gram load, 20 cycles per |
| Test Requirements - all cables | minute +− 90 degrees, 10,000 complete rotation cycles. Cable |
| | must be fully functional after 10,000 cycles |
| validation testing - cable pull | cable must withstand 6 kg pull force applied at angles of 0, 20, |
| testing | and 45 degrees from the centerline; cable must withstand a 10 kg |
| | static pull on axis with the strain relief for 20 minutes; |
| validation testing - abrasion | Abrasion testing per EN 60068-2-32/contact pressure 1.5N; |
| (Plastic parts) | 1 m/minute. |
| validation testing - functional | Two free-fall drops to a concrete floor from 1.5 meter height |
| Drop testing | for 6 planes (total 12 drops). All functionality must be met after |
| | 12 drops. Any parts becoming dislodged may be considered |
| | for reassembly and continuation of the test provided that they |
| | are able to snap together with no tools or excessive force. |

### Example 9

### Encryption of Voice and Data Through a Headphone System Provided Herein

This example describes the end-to-end encryption of voice and data through the computerized pendant. End-to-end encryption (E2EE), which can also be referred to as “non-certified point-to-point encryption,” in some embodiments, can be included in a system provided herein as a digital communications protection. One function of this feature can be to prevent intermediaries, such as Internet providers or application service providers, from being able to discover or tamper with the content of communications.

In some embodiments, an uninterrupted protection of data can be offered to protect data traveling between two communicating parties. The protection can be one-way or two way. It can involve, for example, the originating party encrypting data to be readable only by the intended receiving party in some embodiments, and the receiving party decrypting it, with no involvement in the encryption by third parties.

In some embodiments, the end-to-end encryption can be used, for example, to send email data, instant messaging data, data files, voice data, and radio communications. Examples of such end-to-end encryption include PGP for email; OTR for instant messaging; TRESORIT for cloud storage using encrypted links to send protected files to other parties; Z and Real-time transport protocol (ZRTP), which is a key-agreement protocol for voice data encryption of, for example, voice over internet protocol (VOIP); and, terrestrial trunk radio (TETRA) for encryption of radio information for communications that rely on radio waves. One of skill will appreciate that any one or any combination of the above end-to-end encryption technologies can be used alone or together in any combination. In some embodiments, a computerized pendant herein can be configured with any one or any combination of end-to-end encryption selected from the group consisting of email, instant messaging data, data files, voice data, and radio communications.

For the system to work “two-way” end-to-end each party communicating has to use a device that is configured to interface with the other device. If one party has a device that is not configured to interface with the other device, the encryption can be one-way.

As such, encryption keys can be used in some embodiments. In some embodiments, each party can have an encryption key that is shared with the other party. In some embodiments, each party has a key held in a central directory server. And, in some embodiments, each party has a key that is contained in that party's respective computerized pendant. In some embodiments only one party has an encryption key for accessing data by the other party.

We claim:

1. A method for a first user to share user-created, custom audio profile instructions with a second user, comprising:
as a first user, obtaining a first set of computerized headphones having a first speaker, a processor and a first memory, the memory comprising:
a first receiving module on a non-transitory computer readable medium and operable to receive an input audio data for a song;
a first database on a non-transitory computer readable medium and operable to store the input audio data;
a first transformation module on a non-transitory computer readable storage medium and operable by the first user for transforming the input audio data into a custom output audio profile for the song having a distribution of relative audio amplitudes selected by the first user over a corresponding set of audio frequencies, and creating a set of instructions for the transforming that is configured for sharing with a second set of computerized headphones;
a first output module on a non-transitory computer readable medium and operable to transmit the custom output audio profile for the song to the first speaker; and,
a first data exchange module on a non-transitory computer readable medium and operable to exchange the set of instructions with external computer readable media;
creating the set of instructions with the transformation module for the transforming;
saving the set of instructions on the database; and,
sharing the set of instructions with a second user, the second user having the second set of computerized headphones having a second set of speakers, a second processor and a second memory, the second memory comprising:
a second receiving module on a non-transitory computer readable medium and operable to receive the set of instructions from the external computer readable media;
a second database on a non-transitory computer readable medium and operable to store the input audio data and the set of instructions;
a second transformation module on a non-transitory computer readable storage medium and operable by the second user to transform the input audio data into the custom output audio profile for the song using the set of instructions; and,
a second output module on a non-transitory computer readable medium and operable to transmit the custom output audio profile for the song to the second speaker.

2. The method of claim 1, wherein the first user and the second user are members of a network community and share the set of instructions through the network.

3. The method of claim 1, wherein the first user and the second user are members of a network community and share the set of instructions through the network in a forum that is a public forum, a private forum, a semi-private forum, or a member-only chat room.

4. The method of claim 1, wherein the first user and the second user are members of a network community and share the set of instructions through the network, wherein the network comprises the external computer readable media.

5. The method of claim 1, wherein a data tag corresponding to the song is assigned to the set of audio instructions.

6. The method of claim 1, wherein the sharing occurs through downloading the set of instructions from a server having the external computer readable media to the second set of computerized headphones of the second user.

7. The method of claim 1, wherein the sharing occurs through uploading the set of instructions from the first set of computerized headphones to a server having the external computer readable media, and then downloading to the second set of computerized headphones of the second user.

8. The method of claim 1, wherein the sharing occurs through downloading the set of instructions from the first set of computerized headphones directly to the second set of computerized headphones of the second user.

9. The method of claim 1, wherein the sharing occurs through uploading the set of instructions from the first set of computerized headphones to a server having the external computer readable media, and then downloading to a plurality of users that include the second user having the second set of computerized headphones.

10. The method of claim 1, wherein the first set of computerized headphones further comprises an encryption module on a non-transitory computer readable medium and operable for encrypting data to be readable only by the second user.

11. A system for sharing instructions for a custom audio profile created by a first user with a second user, comprising:
a first set of computerized headphones for a first user having a first speaker, a processor and a first memory, the memory comprising:
a first receiving module on a non-transitory computer readable medium and operable to receive an input audio data for a song;
a first database on a non-transitory computer readable medium and operable to store the input audio data;
a first transformation module on a non-transitory computer readable storage medium and operable by the first user for transforming the input audio data into a custom output audio profile for the song having a distribution of relative audio amplitudes selected by the first user over a corresponding set of audio frequencies, and creating a set of instructions for the transforming that is configured for sharing with a second set of computerized headphones;
a first output module on a non-transitory computer readable medium and operable to transmit the custom output audio profile for the song to the first speaker; and,
a first data exchange module on a non-transitory computer readable medium and operable to exchange the set of instructions with external computer readable media;
wherein the first set of computerized headphones is configured for sharing the set of instructions with a second user having the second set of computerized headphones having a second set of speakers, a second processor and a second memory, the second memory comprising:
a second receiving module on a non-transitory computer readable medium and operable to receive the set of instructions from the external computer readable media;
a second database on a non-transitory computer readable medium and operable to store the input audio data and the set of instructions;
a second transformation module on a non-transitory computer readable storage medium and operable by the second user to transform the input audio data into the custom output audio profile for the song using the set of instructions; and,
a second output module on a non-transitory computer readable medium and operable to transmit the custom output audio profile for the song to the second speaker.

12. The system of claim 11, wherein the first set of computerized headphones is further configured for sharing the set of instructions with the second user through a network having the external computer readable media.

13. The system of claim 11, wherein the system is configured to add a data tag corresponding to the song to the set of audio instructions.

14. The system of claim 11, wherein the first set of computerized headphones further comprises an encryption module on a non-transitory computer readable medium and operable for encrypting data to be readable only by the second user.
